(19) United States
(12) Patent Application Publication
(10) Pub. No.: US 2025/0233735 A1
(43) Pub. Date: Jul. 17, 2025

(54) INFORMATION PROCESSING METHOD, INFORMATION PROCESSING DEVICE, AND INFORMATION PROCESSING SYSTEM

(71) Applicant: Panasonic Intellectual Property Management Co., Ltd., Osaka (JP)

(72) Inventors: Kazuto UENISHI, Fukuoka (JP); Naohisa NISHIDA, Kanagawa (JP); Saburo TOYONAGA, Fukuoka (JP); Kakuya Yamamoto, Hyogo (JP); Takeru KOIE, Saitama (JP)

(21) Appl. No.: 19/169,473

(22) Filed: Apr. 3, 2025

Related U.S. Application Data
(63) Continuation of application No. PCT/JP2023/037660, filed on Oct. 18, 2023.
(60) Provisional application No. 63/417,391, filed on Oct. 19, 2022.

(51) Int. Cl. H04L 9/08; H04L 9/32

(52) U.S. Cl. CPC H04L 9/0825; H04L 9/0891; H04L 9/3247

(57) ABSTRACT

An information processing method that is performed by a device includes: obtaining an owner address that is an address of an owner of the device on a distributed ledger and first authority information that includes information regarding authority of use by the owner of the device; and controlling a distributed ledger system to issue a first non-fungible token (NFT) including the first authority information to the owner address.

### CROSS REFERENCE TO RELATED APPLICATIONS

This is a continuation application of PCT International Application No. PCT/JP2023/037660 filed on Oct. 18, 2023, designating the United States of America, which is based on and claims priority of U.S. Provisional Patent Application No. 63/417,391 filed on Oct. 19, 2022. The entire disclosures of the above-identified applications, including the specifications, drawings and claims are incorporated herein by reference in their entirety.

### FIELD

The present disclosure relates to information processing methods, information processing devices, and information processing systems.

### BACKGROUND

Standards for using information terminals such as smartphones as authentication keys (also referred to as digital keys) to various devices have been established. One example of the standards is the Car Connectivity Consortium (refer to Non Patent Literature (NPL) 1).

### CITATION LIST

### Non Patent Literature

NPL 1: Car Connectivity Consortium, [Sep. 1, 2023], the Internet <URL: https://carconnectivity.org/>.

### SUMMARY

### Technical Problem

However, a problem with the conventional authentication indicated above is that it is not possible to properly control the process of, for example, granting the authority to use a device.

Thus, the present disclosure provides an information processing method that contributes to appropriate control of the authority to use a device.

### Solution to Problem

An information processing method according to one aspect of the present disclosure is performed by a device and includes: obtaining an owner address and first authority information, the owner address being an address of an owner of the device on a distributed ledger, the first authority information including information regarding authority of use by the owner of the device; and controlling a distributed ledger system to issue a first non-fungible token (NFT) including the first authority information to the owner address.

Note that these general and specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

### Advantageous Effects

The present disclosure contributes to appropriate control of the authority to use a device.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the overall configuration of an information processing system in an embodiment.

FIG. 2 is a block diagram illustrating the functional configuration of a vehicle in an embodiment.

FIG. 3 is a block diagram illustrating the functional configuration of a terminal in an embodiment.

FIG. 4 is a block diagram illustrating the functional configuration of a ledger server in an embodiment.

FIG. 5A is an explanatory diagram illustrating the data structure of a blockchain in an embodiment.

FIG. 5B is an explanatory diagram illustrating the data structure of transaction data in an embodiment.

FIG. 6 is an explanatory diagram illustrating one example of information regarding the authority to use a vehicle in an embodiment.

FIG. 7 is an explanatory diagram illustrating one example of information included in an NFT in an embodiment.

FIG. 8 is an explanatory diagram illustrating one example of the hierarchical configuration of NFTs in an embodiment.

FIG. 9 is a sequence diagram illustrating processes performed by an information processing system when a user purchases a vehicle in an embodiment.

FIG. 10 is a sequence diagram illustrating processes performed by an information processing system when an owner uses a vehicle in an embodiment.

FIG. 11 is a first sequence diagram illustrating processes performed by an information processing system when an owner grants the authority of use in an embodiment.

FIG. 12 is a second sequence diagram illustrating processes performed by an information processing system when an owner grants the authority of use in an embodiment.

FIG. 13A is a third sequence diagram illustrating processes performed by an information processing system when an owner grants the authority of use in an embodiment.

FIG. 13B is a sequence diagram illustrating processes performed by an information processing system when a friend uses a vehicle in an embodiment.

FIG. 14 is a first sequence diagram illustrating processes performed by an information processing system when a friend grants the authority of use in an embodiment.

FIG. 15 is a second sequence diagram illustrating processes performed by an information processing system when a friend grants the authority of use in an embodiment.

FIG. 16A is a third sequence diagram illustrating processes performed by an information processing system when a friend grants the authority of use in an embodiment.

FIG. 16B is a sequence diagram illustrating processes performed by an information processing system when a secondary friend uses a vehicle in an embodiment.

FIG. 17 is a first sequence diagram illustrating processes performed by an information processing system when an owner transfers the ownership of a vehicle in an embodiment.

FIG. 18 is a second sequence diagram illustrating processes performed by an information processing system when an owner transfers the ownership of a vehicle in an embodiment.

FIG. 19 is a sequence diagram illustrating processes performed by an information processing system when revocation information is registered in a variation of an embodiment.

FIG. 20 is a sequence diagram illustrating processes performed by an information processing system when an owner uses a vehicle in a variation of an embodiment.

### DESCRIPTION OF EMBODIMENT

### Underlying Knowledge Forming Basis of the Present Disclosure

The inventors found that the following problems occur in the technique described in the “Background” section in which information terminals are used as authentication keys.

When information terminals such as smartphones are used as authentication keys to various devices, authentication required for use of the devices can be easily performed using the information terminals without using physical keys. Furthermore, since this authentication can be easily performed using the information terminals, a proprietor (also referred to as an owner) of a device can easily grant a person who is different from the owner and uses the device (also referred to as a friend) the authority to use the device.

Furthermore, this facilitates management of a history of use of keys and facilitates tracking of persons who have used the keys in the past (in other words, persons who have used the device by using the keys).

However, a problem with the conventional authentication for use of a device is that it is not possible to properly control the process of, for example, granting the authority to use a device. Specifically, the conventional authentication for use of a device has the following problems.

Specifically, the problems with the conventional authentication for use of a device include the problem of not being able to grant, by a friend, another friend the authority of use on a system. Furthermore, there is the problem that when granting the authority of use, contact information of a person who holds the authority of use (the owner or the friend) is not easily obtained on the system. Moreover, there is the problem that when granting the authority of use, value information as remuneration for the granted authority of use is not easily transmitted and received on the system. Furthermore, there is the problem that the transfer of the ownership of a device cannot be managed on the system. Moreover, there is the problem that the cost increases or the power consumption increases because a server that manages the authority of use is required for each device provider (each manufacturer, each seller, or the like).

In view of this, the present disclosure provides an information processing method that contributes to appropriate control of the authority to use a device.

Hereinafter, the disclosure of the present specification will be described as an example, and advantageous effects, etc., obtained from the disclosure will be explained.

(1) An information processing method that is performed by a device includes: obtaining an owner address and first authority information, the owner address being an address of an owner of the device on a distributed ledger, the first authority information including information regarding authority of use by the owner of the device; and controlling a distributed ledger system to issue a first non-fungible token (NFT) including the first authority information to the owner address.

According to this aspect, the device causes the distributed ledger system to issue the first NFT and thereby causes the information regarding the authority of use by the owner of the device to be properly managed on the distributed ledger in a substantially tamper-proof manner. As a result, the authority to use the device based on the authority of use by the owner of the device can be properly controlled. Thus, the information processing method can contribute to appropriate control of the authority to use the device.

(2) Furthermore, the information processing method indicated in (1) further incudes: in controlling one function by the device, obtaining the owner address; obtaining a first storage address that is an address on the distributed ledger at which the first NFT is stored; determining whether there is a match between the owner address and the first storage address; and when it is determined that there is a match between the owner address and the first storage address, controlling the one function.

According to this aspect, before controlling the function of the device, the device confirms that the first NFT is stored at the owner address on the distributed ledger. Using the first NFT properly managed on the distributed ledger, the function of the device can be properly controlled. Since the first NFT is properly managed on the distributed ledger, the function of the device can be properly controlled using the first NFT. Thus, the information processing method can contribute to appropriate control of the authority to use the device.

(3) Furthermore, the information processing method indicated in (1) or (2) further includes: when the owner is to grant a user authority to use the device, obtaining second authority information including information regarding authority of use by the user of the device; and controlling the distributed ledger system to issue a second NFT including the second authority information to a user address that is an address of the user on the distributed ledger.

According to this aspect, the device causes the distributed ledger system to issue the second NFT and thereby causes the information regarding the authority of use by the user of the device to be properly managed on the distributed ledger. As a result, the authority to use the device based on the authority of use by the user of the device can be properly controlled. Thus, the information processing method can contribute to appropriate control of the authority to use the device.

(4) Furthermore, the information processing method indicated in (3) includes: in controlling one function by the device, obtaining the user address; obtaining a second storage address that is an address on the distributed ledger at which the second NFT is stored; determining whether there is a match between the user address and the second storage address; and when it is determined that there is a match between the user address and the second storage address, controlling the one function.

According to this aspect, before controlling the function of the device, the device confirms that the second NFT is stored at the user address on the distributed ledger. Using the second NFT properly managed on the distributed ledger, the function of the device can be properly controlled. Since the second NFT is properly managed on the distributed ledger, the function of the device can be properly controlled using the second NFT. Thus, the information processing method can contribute to appropriate control of the authority to use the device.

(5) In the information processing method indicated in (3) or (4), in the controlling of the distributed ledger system to issue the second NFT, the distributed ledger system is controlled to issue the second NFT according to a smart contract.

According to this aspect, information processing for issuing the second NFT according to the smart contract is performed, and thus the device can cause said information processing to be automatically performed with higher safety than, for instance, when said information processing is performed manually or using other software. Thus, the information processing method can contribute to more appropriate control of the authority to use the device.

(6) Furthermore, the information processing method indicated in any one of (3) to (5) further includes: when the user is to grant a secondary user authority to use the device, obtaining third authority information including information regarding authority of use by the secondary user of the device; and controlling the distributed ledger system to issue a third NFT including the third authority information to a secondary user address that is an address of the secondary user on the distributed ledger.

According to this aspect, the device causes the distributed ledger system to issue the third NFT and thereby causes the information regarding the authority of use by the user of the device to be properly managed on the distributed ledger. As a result, the authority to use the device based on the authority of use by the user of the device can be properly controlled. Thus, the information processing method can contribute to appropriate control of the authority to use the device.

(7) Furthermore, the information processing method indicated in (6) further incudes: in controlling one function by the device, obtaining the secondary user address; obtaining a third storage address that is an address on the distributed ledger at which the third NFT is stored; determining whether there is a match between the secondary user address and the third storage address; and when it is determined that there is a match between the secondary user address and the third storage address, controlling the one function.

According to this aspect, before controlling the function of the device, the device confirms that the third NFT is stored at the user address on the distributed ledger. Using the third NFT properly managed on the distributed ledger, the function of the device can be properly controlled. Since the third NFT is properly managed on the distributed ledger, the function of the device can be properly controlled using the third NFT. Thus, the information processing method can contribute to appropriate control of the authority to use the device.

(8) In the information processing method indicated in (6), in issuing the third NFT, the distributed ledger system is controlled to issue the third NFT according to a smart contract.

According to this aspect, information processing for issuing the third NFT according to the smart contract is performed, and thus the device can cause said information processing to be automatically performed with higher safety than, for instance, when said information processing is performed manually or using other software. Thus, the information processing method can contribute to more appropriate control of the authority to use the device.

(9) Furthermore, the information processing method indicated in any one of (1) to (8) further includes: when a private key of the owner is leaked, performing control to store, into the distributed ledger, revocation information with which the private key of the owner is revoked and to which a digital signature using the private key of the owner has been attached.

According to this aspect, when the private key of the owner is leaked, the device can revoke said private key. The revoked private key cannot function as a private key afterwards, meaning that the use of a device by the leaked private key can be prevented. Thus, the information processing method can contribute to appropriate control of the authority to use the device.

(10) The information processing method indicated in (9) further includes: in controlling one function by the device, obtaining the owner address; obtaining a first storage address that is an address on the distributed ledger at which the first NFT is stored; determining whether the revocation information for the private key of the owner is stored in the distributed ledger; and when it is determined that the revocation information for the private key of the owner is stored in the distributed ledger, prohibiting controlling the one function even when it is determined that there is a match between the owner address and the first storage address.

According to this aspect, using the revocation information for the private key stored in the distributed ledger, the device can prohibit the control of the function that is performed using the leaked private key. Thus, the information processing method can contribute to appropriate control of the authority to use the device.

(11) In the information processing method indicated in any one of (1) to (10), the first authority information includes information indicating a limitation imposed by the owner on use of the device.

According to this aspect, the information indicating the limitation imposed by the owner on the use of the device is included in the first authority information and furthermore stored into the distributed ledger, and thus the device can properly implement the limitation imposed by the owner on the use of the device. Thus, the information processing method can contribute to appropriate control of the authority to use the device.

(12) In the information processing method indicated in (11), the first authority information includes a validity period of the first NFT.

According to this aspect, the information indicating the validity period of the first NFT is included in the first authority information and furthermore stored into the distributed ledger, and thus the device can properly implement, using the validity period of the first NFT, the limitation imposed by the owner on the use of the device. Thus, the information processing method can contribute to appropriate control of the authority to use the device.

(13) In the information processing method indicated in (11), the first authority information includes information indicating presence or absence of authority to issue a second NFT including second authority information including information regarding authority of use by a user of the device.

According to this aspect, the information indicating the presence or absence of the authority to issue the second NFT is included in the first authority information and furthermore stored into the distributed ledger, and thus the device can properly implement, using the information indicating the presence or absence of the authority to issue the second NFT, the limitation imposed by the owner on the use of the device. Thus, the information processing method can contribute to appropriate control of the authority to use the device.

(14) In the information processing method indicated in (11), the first authority information includes function control approval and disapproval information determined for each device.

According to this aspect, the function control approval and disapproval information is included in the first authority information and furthermore stored into the distributed ledger, and thus the device can properly implement, using the function control approval and disapproval information, the limitation imposed by the owner on the use of the device. Thus, the information processing method can contribute to appropriate control of the authority to use the device.

(15) The information processing method indicated in any one of (1) to (14) further includes: in transferring the first NFT by the distributed ledger system, controlling the distributed ledger system to transfer value information as remuneration for the first NFT.

According to this aspect, using the distributed ledger, the device can control the transfer of the value information as the remuneration for the first NFT along with the transfer of the first NFT. Thus, the transfer of the first NFT and the transfer of the value information as remuneration for the first NFT can be collectively managed on the distributed ledger, meaning that the information can be handled more easily and more properly than when the transfer of the first NFT and the transfer of the value information as remuneration for the first NFT are separately managed. Thus, the information processing method can contribute to appropriate control of the authority to use the device.

(16) In the information processing method indicated in (15), in the controlling of the distributed ledger system to transfer the value information, the distributed ledger system is controlled according to a smart contract to transfer the value information.

According to this aspect, information processing for transferring the value information as remuneration for the first NFT according to the smart contract is performed, and thus the device can cause said information processing to be automatically performed with higher safety than, for instance, when said information processing is performed manually or using other software. Thus, the information processing method can contribute to more appropriate control of the authority to use the device.

(17) In the information processing method indicated in any one of (1) to (16), the address on the distributed ledger is an address calculated in advance using a private key of the owner.

According to this aspect, using the private key of the owner, the device can easily calculate the address of the owner on the distributed ledger. Thus, the information processing method can contribute to appropriate control of the authority to use the device.

(18) In the information processing method indicated in (17), the distributed ledger system is controlled using the private key as a digital key defined by the Car Connectivity Consortium (CCC).

According to this aspect, the distributed ledger system can be controlled more easily using the private key as the digital key defined by the CCC. Thus, the information processing method can contribute to appropriate control of the authority to use the device.

(19) An information processing device includes: an obtainer that obtains an owner address and first authority information, the owner address being an address of an owner of the information processing device on a distributed ledger, the first authority information including information regarding authority of use by the owner of the information processing device; and a processor that controls a distributed ledger system to issue a first non-fungible token (NFT) including the first authority information to the owner address.

According to this aspect, the information processing device produces substantially the same advantageous effects as those produced in the aforementioned information processing method.

(20) An information processing system includes: the information processing device indicated in (19); an information processing terminal held by the owner; and the distributed ledger system.

According to this aspect, the information processing system produces substantially the same advantageous effects as those produced in the aforementioned information processing method.

Note that these general and specific aspects may be implemented using a system, a device, an integrated circuit, a computer program, or a computer-readable recording medium such as a CD-ROM, or any combination of systems, devices, integrated circuits, computer programs, and recording media.

Hereinafter, an embodiment will be specifically described with reference to the drawings.

Note that each embodiment described below shows a general or specific example. The numerical values, shapes, materials, structural elements, the arrangement and connection of the structural elements, steps, the processing order of the steps, etc., shown in the following embodiment are mere examples, and are not intended to limit the present disclosure. Therefore, among the structural elements in the following embodiment, structural elements not recited in any one of the independent claims which indicate the broadest concepts will be described as optional structural elements.

### Embodiment

In the present embodiment, an information processing method, an information processing device, and an information processing system that contribute to appropriate control of the authority to use a device will be described.

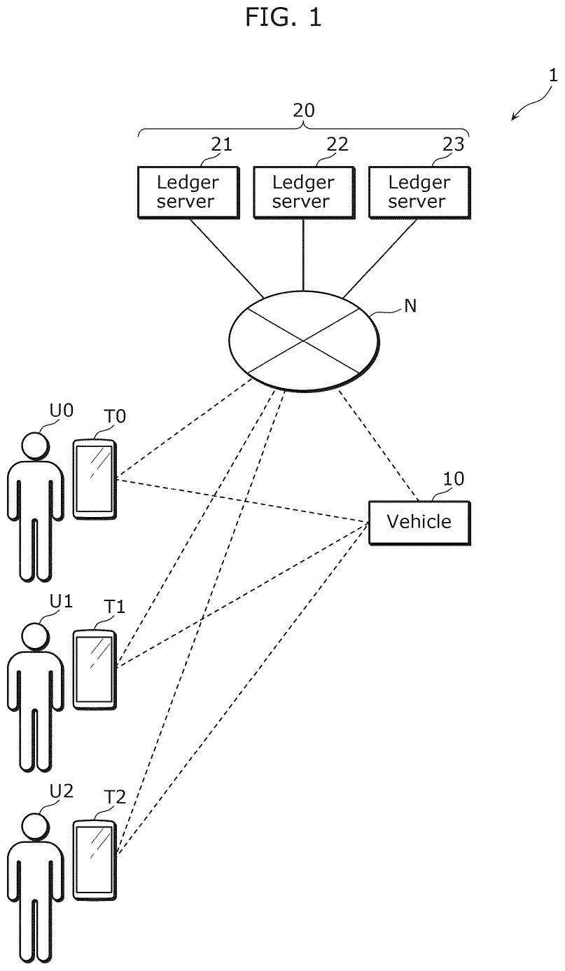

FIG. 1 is a schematic diagram illustrating the overall configuration of information processing system 1 in the present embodiment.

As illustrated in FIG. 1, information processing system 1 includes vehicle 10, distributed ledger system 20, and terminals T0, T1. Information processing system 1 may further include terminal T2.

Vehicle 10 is a vehicle that can be used by user U0, etc. More specific examples of the use of vehicle 10 by user U0 etc., include riding on vehicle 10 and driving vehicle 10 and further include locking and unlocking a door of vehicle 10 and starting a power unit (that is an engine, a motor, or the like) of vehicle 10. The energy source of vehicle 10 may be gasoline, may be electricity, or may be other energy (hydrogen, gas, or the like).

Vehicle 10 is one example of a device that requires a digital key for use. A device that requires a digital key for use can perform a function of said device when authentication using the digital key is successful. Possible examples of the device that requires the digital key for use include houses, gate devices that control the entry and exit of people, and lockers in which luggage, etc., can be stored (namely, storage), other than vehicle 10.

For example, examples of the function to be performed when the authentication using the digital key is successful among the functions of vehicle 10 include locking and unlocking a door of vehicle 10 and starting the power unit (that is an engine, a motor, or the like) of vehicle 10.

Note that examples of the function to be performed when the authentical using the digital key is successful among the functions of a house include locking and unlocking a front door of the house. Examples of the function to be performed when the authentication using the digital key is successful among the functions of a gate device include gate opening/closing control. Examples of the function to be performed when the authentical using the digital key is successful among the functions of a locker include locking and unlocking a door of the locker.

Assume that user U0 owns vehicle 10. Furthermore, assume that user U0 has granted user U1 the authority to use vehicle 10 and user U1 has granted user U2 the authority to use vehicle 10. In this case, user U0 may correspond to an owner. User U1 may correspond to a friend. User U2 may correspond to a secondary friend.

Distributed ledger system 20 is a system that holds and manages a distributed ledger. In the distributed ledger, an NFT including information regarding the authority to use vehicle 10 is stored, and various transaction data regarding the authority to use vehicle 10 is further stored.

Distributed ledger system 20 includes ledger servers 21, 22, 23 as a server group that holds the distributed ledger. Note that the number of ledger servers included in said server group is not limited to three and may be greater than three.

Ledger server 21 is a server device that holds and manages the distributed ledger. Ledger server 21, which holds the distributed ledger, updates the distributed ledger by synchronizing the distributed ledger with another ledger server 22, etc.

Each of the ledger servers 22, 23, which is substantially the same server as ledger server 21, operates independently of ledger server 21.

Terminal T0 is an information terminal device held by user U0. User U0 is an owner who is a user owning vehicle 10. The information terminal device is, for example, a smartphone, a tablet, a personal computer, or the like. The same applies to the following cases.

Terminal T1 is an information terminal device held by user U1. User U1 is a user granted the authority to use vehicle 10 by user U0 who is the owner of vehicle 10 (also referred to as a friend).

Terminal T2 is an information terminal device held by user U2. User U2 is a user granted the authority to use vehicle 10 by user U1 who is a friend (also referred to as a secondary user or a secondary friend).

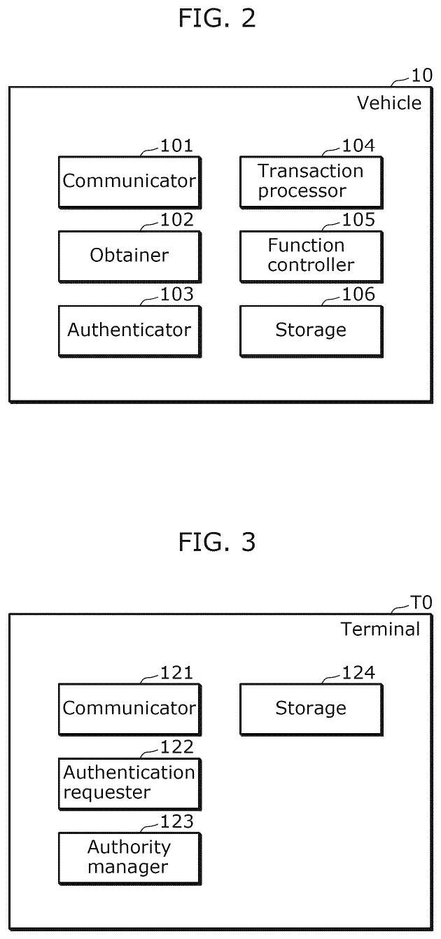

FIG. 2 is a block diagram illustrating the functional configuration of vehicle 10 in the present embodiment.

Vehicle 10 includes communicator 101, obtainer 102, authenticator 103, transaction processor 104, function controller 105, and storage 106 as function units. Obtainer 102, authenticator 103, transaction processor 104, and function controller 105 can be realized by a processor (for example, a central processing unit (CPU)) included vehicle 10 executing a predetermined program using memory.

Communicator 101 is a communication interface that is connected to terminal T0, etc. The communication interface that is connected to terminal T0, etc., is, for example, a communication interface that complies with a communication standard of short-range communication (for example, Bluetooth (registered trademark) or near-field communication (NFC)), but may be a communication interface that performs wireless communication in compliance with another standard.

Communicator 101 is a communication interface that is connected to network N. The communication interface that is connected to network N may be, for example, a communication interface that complies with a communication standard of wireless communication (for example, a mobile communication system (the 3^{rd} generation (3G), the 4^{th} generation (4G), the 5^{th} generation (5G), or the like)). Communicator 101 is used by a function unit of vehicle 10 to communicate with another device.

Obtainer 102 obtains: the wallet address of user U0, etc., in the distributed ledger (also referred to simply as an address); and authority information including information regarding authority of use by said user U0, etc., of vehicle 10. The wallet address, which is an address indicating an account of said user in the distributed ledger, is unique to said user.

Specifically, obtainer 102 obtains, from terminal T0 via communicator 101, the address of user U0 who is the owner of vehicle 10 in the distributed ledger (also referred to as an owner address or a proprietor address) and authority information including information regarding authority of use by the owner of vehicle 10 (also referred to as first authority information).

Note that the first authority information may include information indicating limitations imposed by the owner on the use of vehicle 10. Specifically, the first authority information may include the validity period of the first NFT. The first authority information may include information indicating the presence or absence of the authority to issue the second NFT. Furthermore, the first authority information may include function control approval and disapproval information determined for each vehicle 10.

Furthermore, obtainer 102 can obtain, from terminal T1 via communicator 101, the address of user U1 who is a friend of vehicle 10 on the distributed ledger (also referred to as a friend address or a user address) and authority information including information regarding the authority of use by a friend of vehicle 10 (also referred to as second authority information).

Furthermore, obtainer 102 can obtain, from terminal T2 via communicator 101, the address of user U2 who is a secondary friend of vehicle 10 on the distributed ledger (also referred to as a secondary friend address or a secondary user address) and authority information including information regarding the authority of use by a secondary friend of vehicle 10 (also referred to as third authority information).

Authenticator 103 is a processor that performs an authentication process for the owner, the friend, or the secondary friend (also referred to as the owner, etc.). Authenticator 103 performs this authentication process during issuance of an NFT including the information regarding the authority of use by the owner, etc. of vehicle 10 or during control of a function of vehicle 10.

Transaction processor 104 controls distributed ledger system 20 by performing a process related to a transaction. Transaction processor 104 is also referred to as a processor.

Specifically, transaction processor 104 generates transaction data including information and transmits the generated transaction data to distributed ledger system 20 so that the generated transaction data is stored into the distributed ledger. The transaction data may include issuance transaction data with which an NFT is issued, for example.

For example, transaction processor 104 generates transaction data with which an NFT including information regarding the authority of use by the owner of vehicle 10 (that corresponds to the first NFT) is issued to the owner address, and controls distributed ledger system 20 so that the generated transaction data is stored into the distributed ledger.

Furthermore, transaction processor 104 can control distributed ledger system 20 so that when the first NFT is transferred in distributed ledger system 20, value information as remuneration for the first NFT is transferred. At this time, transaction processor 104 may control distributed ledger system 20 such that the value information is transferred according to a smart contract.

Furthermore, for example, transaction processor 104 generates transaction data with which an NFT including the information regarding the authority of use by the friend of vehicle 10 (that corresponds to the second NFT) is issued to a friend address which is the address of the friend on the distributed ledger, and controls distributed ledger system 20 so that the generated transaction data is stored into the distributed ledger.

Furthermore, for example, transaction processor 104 generates transaction data with which an NFT including the information regarding the authority of use by the secondary friend of vehicle 10 (that corresponds to the third NFT) is issued to a secondary friend address which is the address of the secondary friend on the distributed ledger, and controls distributed ledger system 20 so that the generated transaction data is stored into the distributed ledger.

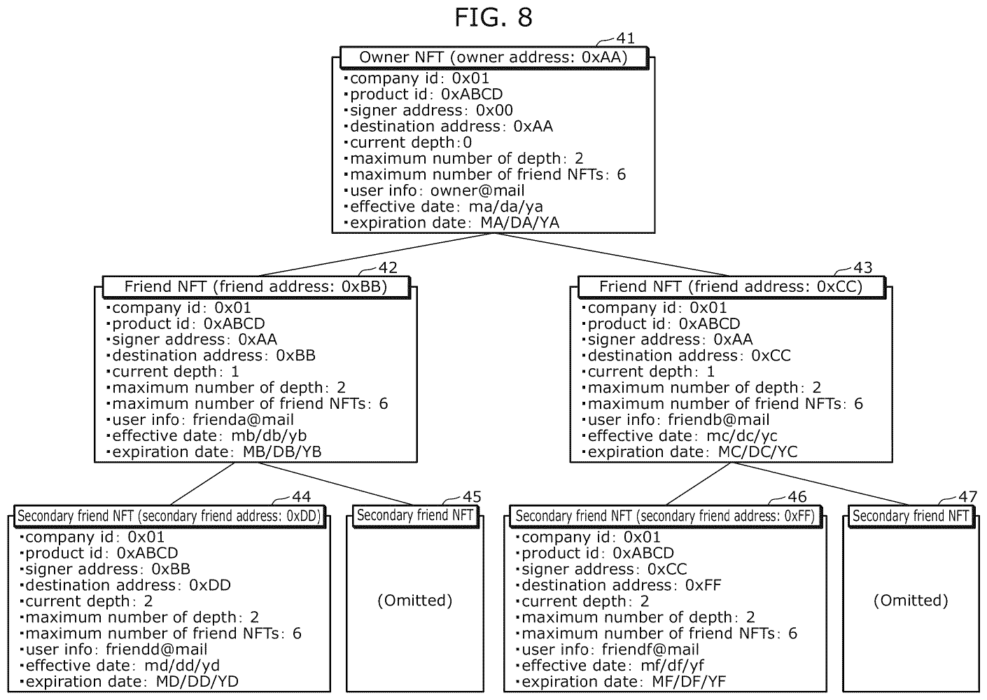

The aforementioned NFTs (specifically, the first NFT, the second NFT, and the third NFT) are managed by distributed ledger system 20 so as to have a hierarchical configuration (refer to FIG. 8).

Function controller 105 controls a function of vehicle 10. Function controller 105 controls, for example, locking and unlocking of a door of vehicle 10 or the start of a power unit (that is an engine, a motor, or the like) of vehicle 10 as a function of vehicle 10.

When controlling said function, function controller 105 can confirm that the first NFT is stored at the owner address before controlling said function.

Specifically, when controlling said function, function controller 105 obtains the owner address and obtains a first storage address that is an address on the distributed ledger at which the first NFT is Subsequently, function controller 105 can determine stored. whether there is a match between the owner address and the first storage address, and when determining that there is a match between the owner address and the first storage address, control said function.

Furthermore, when controlling said function, function controller 105 can confirm that the second NFT is stored at the friend address before controlling said function.

Specifically, when controlling said function, function controller 105 obtains the friend address and obtains a second storage address that is an address on the distributed ledger at which the second NFT is stored. Subsequently, function controller 105 can determine whether there is a match between the friend address and the second storage address, and when determining that there is a match between the friend address and the second storage address, control said function.

Furthermore, when controlling said function, function controller 105 can confirm that the third NFT is stored at the secondary friend address before controlling said function.

Specifically, when controlling said function, function controller 105 obtains the secondary friend address and obtains a third storage address that is an address on the distributed ledger at which the third NFT is stored. Subsequently, function controller 105 determines whether there is a match between the secondary user address and the third storage address, and when determining that there is a match between the secondary user address and the third storage address, controls said function.

Storage 106 is a storage device in which information is stored. In storage 106, specifically, the authority information and the public key of user U0, etc., can be stored. Storage 106 is realized by a semiconductor storage device (random access memory (RAM), solid state drive (SSD), or the like), a magnetic storage device (hard disk drive (HDD)), or the like.

FIG. 3 is a block diagram illustrating the functional configuration of terminal T0 in the present embodiment.

Terminal T0 includes communicator 121, authentication requester 122, authority manager 123, and storage 124. Authentication requester 122 and authority manager 123 may be realized by a processor (for example, CPU) included in terminal T0 executing a predetermined program using memory. Note that each of terminals T1, T2 includes substantially the same structural elements as terminal T0.

Communicator 121 is a communication interface that is connected to vehicle 10. The communication interface that is connected to vehicle 10 is, for example, a communication interface that complies with a communication standard of short-range communication (for example, Bluetooth (registered trademark) or near-field communication (NFC)), but may be a communication interface that performs wireless communication in compliance with another standard.

Communicator 121 is a communication interface that is connected to network N. The communication interface that is connected to network N may be, for example, a communication interface that complies with a communication standard of wireless communication (for example, a mobile communication system (3G, 4G, 5G, or the like)).

Communicator 121 is used by a function unit of terminal T0 to communicate with another device.

Authentication requester 122 makes an authentication request to authenticate user U0 who holds terminal T0. Authentication requester 122 makes this authentication request during issuance of an NFT including the information regarding the authority of use by the owner, etc. of vehicle 10 or during control of a function of vehicle 10.

Authority manager 123 manages authority information that is information regarding the authority to use vehicle 10. Specifically, authority manager 123 accepts, from user U0, input of the information regarding the authority to use vehicle 10, using a user interface (an operation unit, a display, and the like) of terminal T0, and generates or updates the authority information. Furthermore, authority manager 123 transmits the authority information held therein to vehicle 10.

Storage 124 is a storage device in which information is stored. In storage 124, the private key of user U0 who holds terminal T0 is stored. Furthermore, the public key of vehicle 10 is stored in storage 124. Storage 124 is realized by a semiconductor storage device (RAM, SSD, or the like), a magnetic storage device (HDD), or the like.

Note that storage 124 may include a secure element with a relatively high security strength, and the private key of user U0 may be stored in the secure element. With this, the risk of leakage of the private key of user U0 can be reduced.

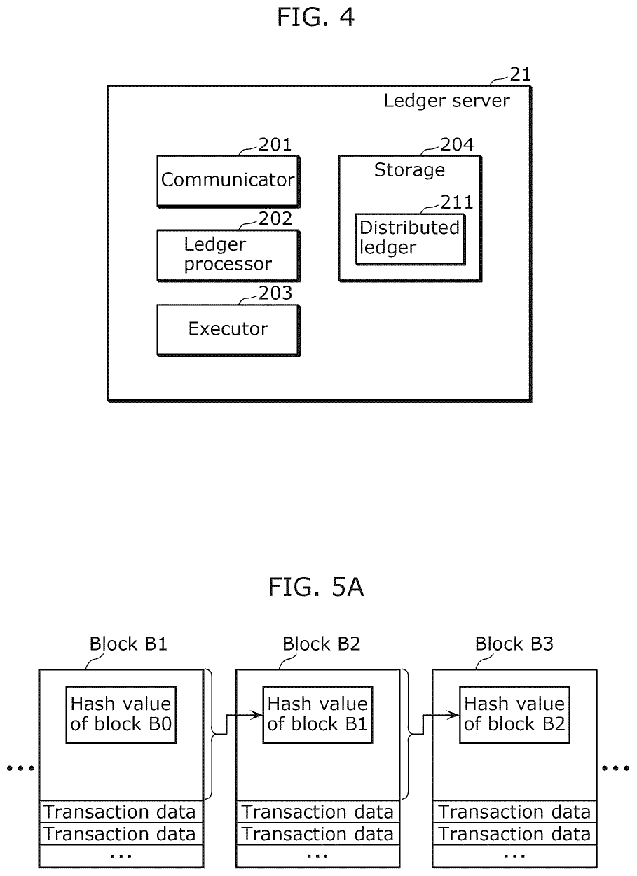

FIG. 4 is a block diagram illustrating the functional configuration of ledger server 21 in the present embodiment.

Ledger server 21 includes communicator 201, ledger processor 202, executor 203, and storage 204.

Communicator 201 is a communication interface that is connected to network N so as to allow communication therebetween. Communicator 201 may be a communication interface that complies with a communication standard of wired communication (for example, Ethernet (registered trademark) or the like) or may be a communication interface that complies with a communication standard of wireless communication (for example, Wi-Fi (registered trademark) or the like or a mobile communication system (3G, 4G, 5G, or the like)). Communicator 201 is used by a function unit of ledger server 21 to communicate with another device.

Ledger processor 202 performs a process regarding the distributed ledger or the transaction data. Specifically, when ledger processor 202 receives the transaction data from vehicle 10 or terminal T0, etc., ledger processor 202 verifies a signature on the transaction data received and performs control such that the transaction data successfully verified is stored into the distributed ledger held in storage 204. In storing the transaction data into the distributed ledger, ledger processor 202 performs control so as to generate a block including the transaction data to be stored, and execute a consensus algorithm for the generated block among this ledger processor 202 and ledger processors 202 of other ledger servers, i.e., ledger servers 22, 23, and when an agreement is formed, store said block into the distributed ledger. Note that as the consensus algorithm, practical byzantine fault tolerance (PBFT) may be used, or proof of work (PoW), proof of stake (PoS), or the like may be used. Note that when Hyperledger Fabric is used as one example of the distributed ledger technology, the consensus algorithm does not need to be executed.

Executor 203 executes the smart contract. Specifically, when the transaction data including a command for executing the smart contract is stored into distributed ledger 211, executor 203 reads the contract code of said smart contract from distributed ledger 211 and executes the smart contract.

Storage 204 is a storage device in which information is stored. In storage 204, distributed ledger 211 is stored. Storage 204 is realized by a non-volatile storage device (SSD or HDD) or the like.

Distributed ledger 211 includes data having a structure in which blocks including one or more transaction data are linked in the form of a chain.

The transaction data includes transaction data indicating transmission and reception of a token between users. An example of the token is general value information (monetary value or information equivalent to monetary value). Another example of the token is a non-fungible token (NFT) corresponding to a digital key. It can also be said that the NFT corresponding to the digital key is an NFT indicating the validity of the digital key or an NFT for proving the validity of the digital key.

The transaction data includes transaction data including the contract code of the smart contract, transaction data including a command for executing the smart contract, or transaction data including other information.

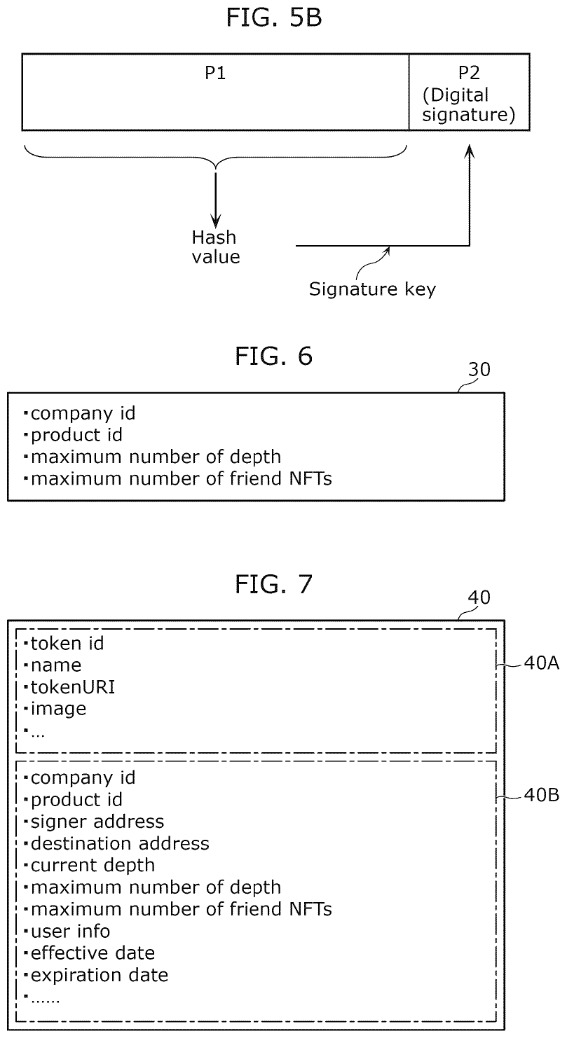

FIG. 5A is an explanatory diagram illustrating the data structure of a blockchain.

A blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

FIG. 5B is an explanatory diagram illustrating the data structure of transaction data.

The transaction data illustrated in FIG. 5B includes transaction body P1 and digital signature P2. Transaction body P1 is a data body included in said transaction data. Digital signature P2 is generated by signing the hash value of transaction body P1 with a signature key of a creator of said transaction data; more specifically, digital signature P2 is generated by encrypting the hash value of transaction body P1 with a private key of the creator.

Because of including digital signature P2, the transaction data is virtually impossible to tamper with. Thus, the transaction body is protected from tampering.

FIG. 6 is an explanatory diagram illustrating one example of information regarding the authority to use vehicle 10 in the present embodiment.

Information 30 illustrated in FIG. 6 is, for example, information regarding the authority to use vehicle 10 that obtainer 102 in vehicle 10 accepts from the owner (namely, user U0).

As illustrated in FIG. 6, information 30 includes company id, product id, maximum number of depth, and maximum number of friend NFTs.

Company id is an identifier of a company that has provided vehicle 10. The company that has provided vehicle 10 may be a company that has manufactured vehicle 10 or may be a company that has sold vehicle 10.

Product id is an identifier that can uniquely identify vehicle 10.

Maximum number of depth is the upper limit value of the depth of the hierarchy in the hierarchical configuration.

Maximum number of friend NFTs is the upper limit value of the total number of friends (the total number of friend NFTs and secondary friend NFTs).

FIG. 7 is an explanatory diagram illustrating information included in an NFT in the present embodiment.

NFT 40 illustrated in FIG. 7 includes token id, name, tokenURI, image, company id, product id, signer address, destination address, current depth, maximum number of depth, maximum number of friend NFTs, user info, effective date, and expiration date.

In the information included in NFT 40, information 40A (specifically, token id, name, tokenURI, and image) is information included in a typical NFT and therefore, detailed description of information 40A will be omitted.

In the information included in NFT 40, information 40B (specifically, company id, product id, signer address, destination address, current depth, maximum number of depth, maximum number of friend NFTs, user info, effective date, and expiration date) is information uniquely included in the NFT corresponding to the digital key. This will be described in detail below.

Company id is an identifier of a company that has provided vehicle 10. The company that has provided vehicle 10 may be a company that has manufactured vehicle 10 or may be a company that has sold vehicle 10.

Product id is an identifier that can uniquely identify vehicle 10.

Signer address is an address of a user who has signed said NFT 40. The user who has signed said NFT 40 corresponds to an address of a user who has granted the authority of use by said NFT 40.

Destination address is an address to which said NFT 40 is issued. The address to which said NFT 40 is issued corresponds to an address of a user who is granted the authority of use by said NFT 40.

Current depth is the hierarchical level (depth) of said NFT 40. A deeper hierarchical level has a greater value. For example, it can be assumed that the hierarchical level of the owner NFT is 0, the hierarchical level of the friend NFT is 1, and the hierarchical level of the secondary friend NFT is 2; this example will be described.

Maximum number of depth is the upper limit value of the depth of a hierarchical level.

Maximum number of friend NFTs is the upper limit value of the number of friend NFTs.

User info is information regarding a person to which said NFT is issued and may include, for example, an e-mail address or social networking service (SNS) account information as contact information of a person to which said NFT is issued.

Effective date is information indicating a date on which said NFT is issued.

Expiration date is information indicating a date scheduled for said NFT to expire, that is, information indicating the validity period of said NFT.

Note that NFT 40 may include information indicating whether to permit exclusive use of vehicle 10 by a friend or a secondary friend (for example, exclusive use of friend). Exclusive use of friend can have one of two values that are “permit (for example, 1)” and “not permit “for example, 0).” When exclusive use of friend is “permit,” only the friend to which said friend NFT has been issued has the authority to use vehicle 10 and other owners or friends cannot use vehicle 10 while said friend NFT is valid.

FIG. 8 is an explanatory diagram illustrating the hierarchical configuration of NFTs in the present embodiment.

FIG. 8 shows a plurality of NFTs 41, 42, 43, 44, 45, 46, and 47 in the hierarchical configuration. Among the plurality of NFTs 41, etc., shown in FIG. 8, an NFT at a deeper level (in other words, with a higher depth) is drawn at a lower position.

NFT 41 is one example of the owner NFT including the information regarding the authority of use by the owner of vehicle 10. NFT 41 is stored at 0xAA which is the address of user U0 who is the owner.

In NFT 41, company id, product id, maximum number of depth, and maximum number of friend NFTs can be set to values determined as the authority information by the owner.

In NFT 41, signer address is set to 0x00. This indicates that no one has granted user U0 the authority to use vehicle 10, that is, user U0 is the owner.

In NFT 41, destination address is set to 0xAA. This indicates that said NFT 41 is an NFT issued to user U0.

The depth (current depth) of NFT 41 is 0. This is consistent with the fact that user U0 is the owner.

In NFT 41, user info is set to an e-mail address as the contact information of user U0 who has an address to which said NFT 41 has been issued.

NFT 42 is one example of the friend NFT including the information regarding the authority of use by the friend of vehicle 10. NFT 42 is stored at 0xBB which is the address of user U1 who is the friend.

In NFT 42, company id, product id, maximum number of depth, and maximum number of friend NFTs can be set to values determined as the authority information by the owner, similar to NFT 41.

In NFT 42, signer address is set to 0xAA. This indicates that the person who has granted user U1 the authority to use vehicle 10 is user U0 who is the owner. This is consistent with the fact that user U1 is the friend.

In NFT 42, destination address is set to 0xBB. This indicates that said NFT 42 is an NFT issued to user U1.

The depth (current depth) of NFT 42 is 1. This is consistent with the fact that user U1 is the friend.

In NFT 42, user info is set to an e-mail address as the contact information of user U1 who has an address to which said NFT 42 has been issued.

NFT 43 includes the information regarding the authority of use by the friend of vehicle 10, similar to NFT 42. NFT 43 is stored at 0xCC which is the address of a friend (not illustrated in the drawings) different from user U1. The information included in NFT 43, which is as shown in FIG. 8, may be set as in NFT 42 and thus, description thereof will be omitted.

NFT 44 is one example of the secondary friend NFT including the information regarding the authority of use by the secondary friend of vehicle 10. NFT 44 is stored at 0xDD which is the address of user U2 who is the secondary friend.

In NFT 44, company id, product id, maximum number of depth, and maximum number of friend NFTs can be set to values determined as the authority information by the owner, similar to NFT 41.

In NFT 44, signer address is set to 0xBB. This indicates that the person who has granted user U2 the authority to use vehicle 10 is user U1 who is the friend.

In NFT 44, destination address is set to 0xDD. This indicates that said NFT 44 is an NFT issued to user U2.

The depth (current depth) of NFT 44 is 2. This is consistent with the fact that user U1 is the secondary friend.

In NFT 44, user info is set to an e-mail address as the contact information of user U2 who has an address to which said NFT 44 has been issued.

NFTs 45, 46, 47 include the information regarding the authority of use by the secondary friend of vehicle 10, similar to NFT 44. For example, NFT 46 is stored at 0xFF which is the address of a secondary friend (not illustrated in the drawings) different from user U2. The information included in NFT 46, which is as shown in FIG. 8, may be set as in NFT 44 and thus, description thereof will be omitted.

The following describes the processes performed by information processing system 1.

First described are processes in which information processing system 1 issues the owner NFT to user U0 who purchases vehicle 10.

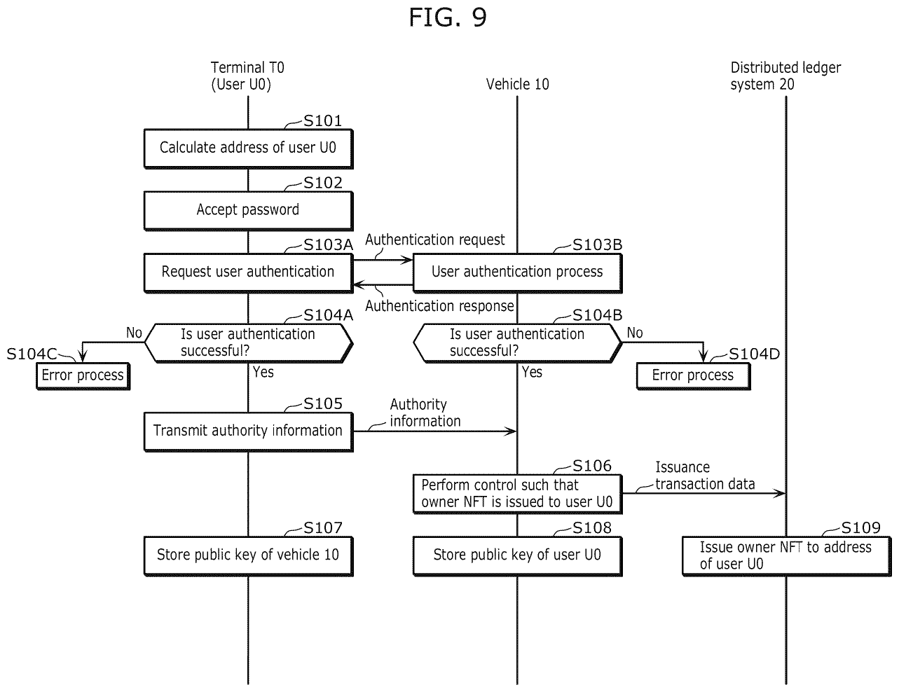

FIG. 9 is a sequence diagram illustrating the processes performed by information processing system 1 when user U0 purchases vehicle 10 in the present embodiment.

In Step S101, authentication requester 122 in terminal T0 calculates the address of user U0. Authentication requester 122 can calculate the address of user U0 by using the private key of user U0 stored in storage 124. The calculation of the address by using the private key can be achieved using a well-known technique (for example, a public key is calculated from the private key by using an elliptic curve equation and then, the address is calculated from the public key by using a hashing operation or the like).

In Step S102, authentication requester 122 in terminal T0 accepts a password from user U0. The password accepted by authentication requester 122 from user U0 may be a password provided by a sales company or the like when user U0 purchase vehicle 10 from the sales company. The fact that the sales company or the like provides a password for user U0 indicates that user U0 is indeed a user who purchased vehicle 10. The password accepted by authentication requester 122 from user U0 may be used to authenticate that user U0 is a user who purchased vehicle 10.

In Step S103A, authentication requester 122 in terminal T0 requests vehicle 10 to perform user authentication. In the request for user authentication, authentication requester 122 requests password authentication for user U0 by transmitting, to vehicle 10, an authentication request including the address of user U0 and the password accepted in Step S102. Furthermore, authentication requester 122 in terminal T0 receives an authentication response including the result of the authentication from vehicle 10.

In Step S103B, authenticator 103 in vehicle 10 receives the authentication request transmitted thereto in Step S103A, and performs the process of authentication (password authentication) of user U0 by using the address of user U0 and the password included in the authentication request. Authenticator 103 in vehicle 10 transmits an authentication response including the result of the authentication (specifically, indicating whether the authentication is successful or unsuccessful) to terminal T0.

In Step S104A, from the authentication response received in Step S103A, authentication requester 122 in terminal T0 determines whether the authentication in Step S103B is successful. When it is determined that the above authentication is successful (Yes in Step S104A), the processing proceeds to Step S105; otherwise (No in Step S104A), the processing proceeds to Step S104C.

In Step S104C, terminal T0 performs an error process. For example, as the error process, terminal T0 may display the result of the above authentication on a display screen or may output the result of the above authentication as sound and speech from a loudspeaker. Subsequently, information processing system 1 ends the series of processes illustrated in FIG. 9.

In Step S104B, authenticator 103 in vehicle 10 determines whether the authentication in Step S103B is successful. When it is determined that the above authentication is successful (Yes in Step S104B), the processing proceeds to Step S106; otherwise (No in Step S104B), the processing proceeds to Step S104D.

In Step S104D, vehicle 10 performs an error process. For example, as the error process, vehicle 10 may display the result of the above authentication on a display screen or may output the result of the above authentication as sound and speech from a loudspeaker. Subsequently, information processing system 1 ends the series of processes illustrated in FIG. 9.

In Step S105, authority manager 123 in terminal T0 transmits the information regarding the authority to use vehicle 10. The information regarding the authority to use vehicle 10 includes, for example, company id, product id, maximum number of depth, and maximum number of friend NFTs (refer to FIG. 6). Vehicle 10 receives the information transmitted thereto.

In Step S106, transaction processor 104 in vehicle 10 performs control such that the owner NFT is issued to user U0. Specifically, transaction processor 104 in vehicle 10 generates transaction data including information for causing the owner NFT to be issued to user U0 (also referred to as issuance transaction data), and transmits the transaction data to distributed ledger system 20. Distributed ledger system 20 receives the issuance transaction data transmitted thereto.

Note that in the transmitting of the transaction data to distributed ledger system 20, it is sufficient that said transaction data be transmitted to one ledger server among the plurality of ledger servers 21, etc., included in distributed ledger system 20. The transaction data transmitted is shared with the plurality of ledger servers 21, etc., and stored into the distributed ledger by distributed ledger system 20. The same applies to the following cases.

In Step S107, authority manager 123 in terminal T0 stores the public key of vehicle 10 into storage 124. When the public key of vehicle 10 is stored in terminal T0, the next and subsequent signature verification can be performed rapidly. The public key to be stored is relatively reliable as a public key of vehicle 10, meaning that the public key can be used without repeated validity verification thereof; in other words, the process of validity verification can be omitted.

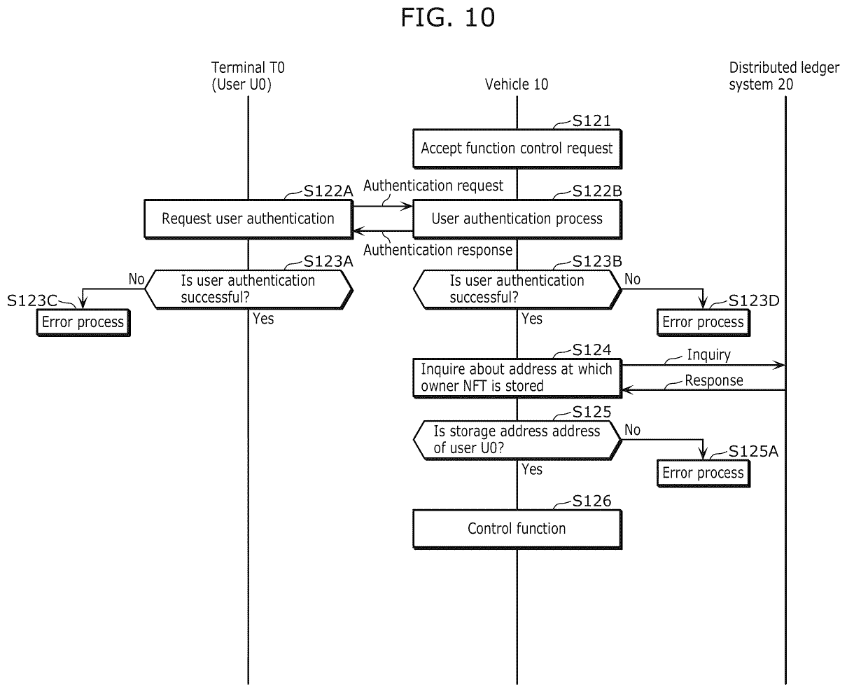

Furthermore, when the public key of vehicle 10 is stored in terminal T0, the stored public key of vehicle 10 can be handed over to another person upon assignment of the owner NFT to the other person. The public key of vehicle 10 is needed for the control of a function of vehicle 10 (refer to FIG. 10, Step S126). Upon the assignment of the owner NFT to another person, the public key of vehicle 10 is transmitted to a terminal held by the other person (in other words, an assignee), meaning that said terminal no longer needs to perform the process of obtaining the public key of vehicle 10 from vehicle 10 or the process of verifying the obtained public key of vehicle 10, which can contribute to reduced processing load on the terminal.

Note that the simple phrase “the public key of vehicle 10” may refer to a public key certificate including the public key of vehicle 10. The same applies to the following cases. This also holds true for “the public key of a user,” specifically, “the public key of user U0,” “the public key of user U1,” “the public key of user U2,” “the public key of user U10,” and the like.

In Step S108, vehicle 10 stores the public key of user U0 into storage 106. When the public key of user U0 is stored in vehicle 10, the next and subsequent verification of a signature generated using the private key of user U0 can be performed rapidly.

In Step S109, distributed ledger system 20 issues the owner NFT to the address of user U0 according to the reception of the issuance transaction data in Step S106.

Through the series of processes illustrated in FIG. 9, information processing system 1 can issue the owner NFT to user U0 who purchases vehicle 10.

Next described is the process of controlling a function of vehicle 10 according to the request from the owner when the owner uses vehicle 10.

FIG. 10 is a sequence diagram illustrating the processes performed by information processing system 1 when the owner uses vehicle 10 in the present embodiment.

In Step S121, vehicle 10 accepts a function control request from user U0 that requests control of a function. This function is a function to be controlled by function controller 105.

When said function is locking or unlocking of a door of vehicle 10 as an example, accepting the function control request from user U0 corresponds to receiving, from terminal T0 via short-range wireless communication, information indicating that user U0 has operated terminal T0 to lock or unlock the door. Accepting the function control request from user U0 may be operating a door locking/unlocking operation button on terminal T0 by user U0.

In Step S122A, authentication requester 122 in terminal T0 requests vehicle 10 to perform user authentication. For example, authentication requester 122 in terminal T0 requests authentication of user U0 by the challenge-response method. Furthermore, authentication requester 122 in terminal T0 receives an authentication response including the result of the authentication from vehicle 10.

In Step S122B, authenticator 103 in vehicle 10 receives the authentication request transmitted thereto in Step S122A, and performs the process of authenticating user U0 by the challenge-response method. Authenticator 103 in vehicle 10 transmits an authentication response including the result of the authentication (specifically, indicating whether the authentication is successful or unsuccessful) to terminal T0.

In Step S123A, from the authentication response received in Step S122A, authentication requester 122 in terminal T0 determines whether the authentication in Step S122B is successful. When it is determined that the above authentication is successful (Yes in Step S123A), terminal T0 ends the series of processes illustrated in FIG. 10; otherwise (No in Step S123A), the processing proceeds to Step S123C.

In Step S123C, terminal T0 performs an error process. For example, as the error process, terminal T0 may display the result of the above authentication on the display screen or may output the result of the above authentication as sound and speech from the loudspeaker. Subsequently, information processing system 1 ends the series of processes illustrated in FIG. 10.

In Step S123B, authenticator 103 in vehicle 10 determines whether the authentication in Step S122B is successful. When it is determined that the above authentication is successful (Yes in Step S123B), the processing proceeds to Step S124; otherwise (No in Step S123B), the processing proceeds to Step S123D.

In Step S123D, vehicle 10 performs an error process. For example, as the error process, vehicle 10 may display the result of the above authentication on the display screen or may output the result of the above authentication as sound and speech from the loudspeaker. Subsequently, information processing system 1 ends the series of processes illustrated in FIG. 10.

In Step S124, transaction processor 104 in vehicle 10 inquires of distributed ledger system 20 about an address on the distributed ledger at which the owner NFT is stored (also referred to as a storage address), and receives a response including said storage address.

In Step S125, transaction processor 104 in vehicle 10 determines whether the storage address included in the response received in Step S124 is the address of user U0. When it is determined that the storage address is the address of user U0 (Yes in Step S125), the processing proceeds to Step S126; otherwise (No in Step S125), the processing proceeds to Step S125A.

In Step S126, function controller 105 in vehicle 10 controls the function of vehicle 10 according to the request accepted in Step S121.

Through the series of processes illustrated in FIG. 10, information processing system 1 can control the function of vehicle 10 according to the request from the owner when the owner uses vehicle 10.

Next described are the processes performed by information processing system 1 when user U0, who is the owner, grants user U1 the authority to use vehicle 10. Note that user U1 becomes a friend of vehicle 10 when granted the authority to use vehicle 10.

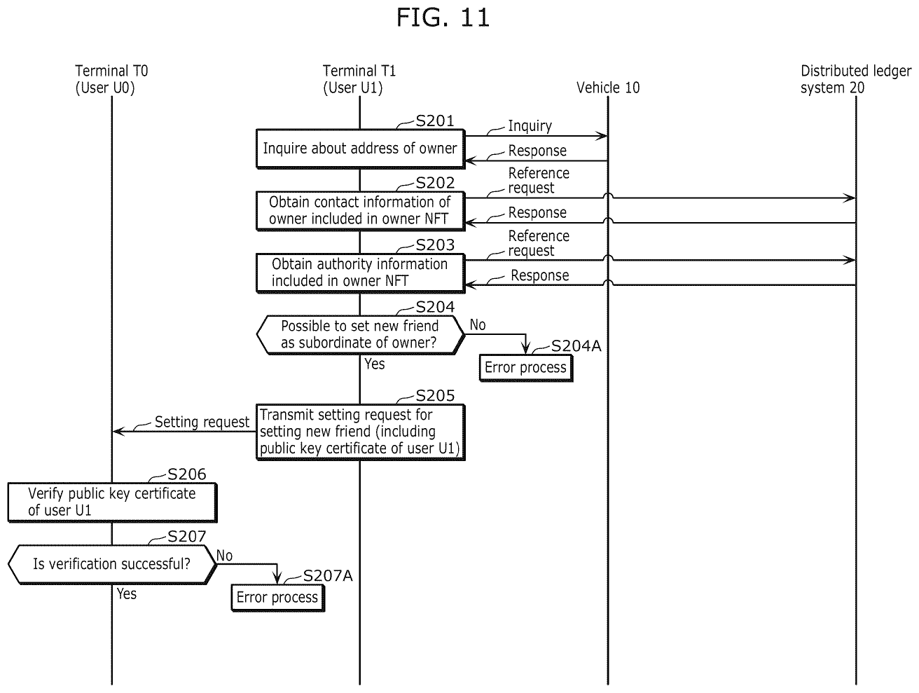

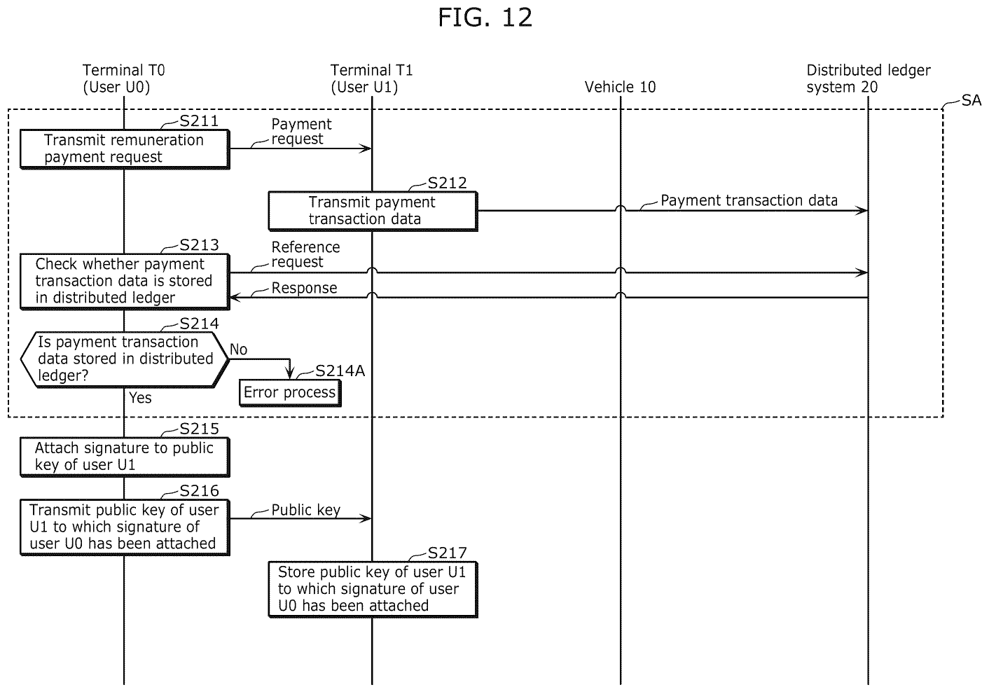

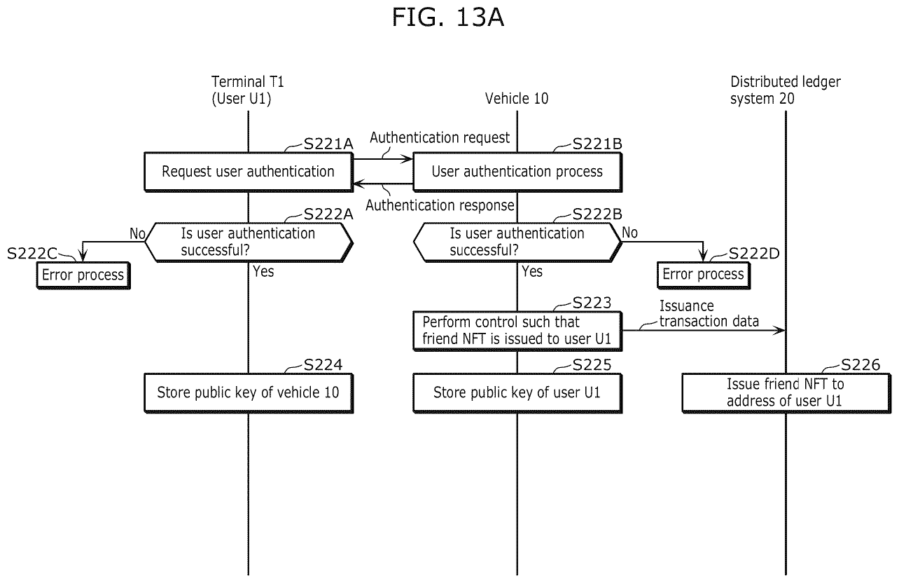

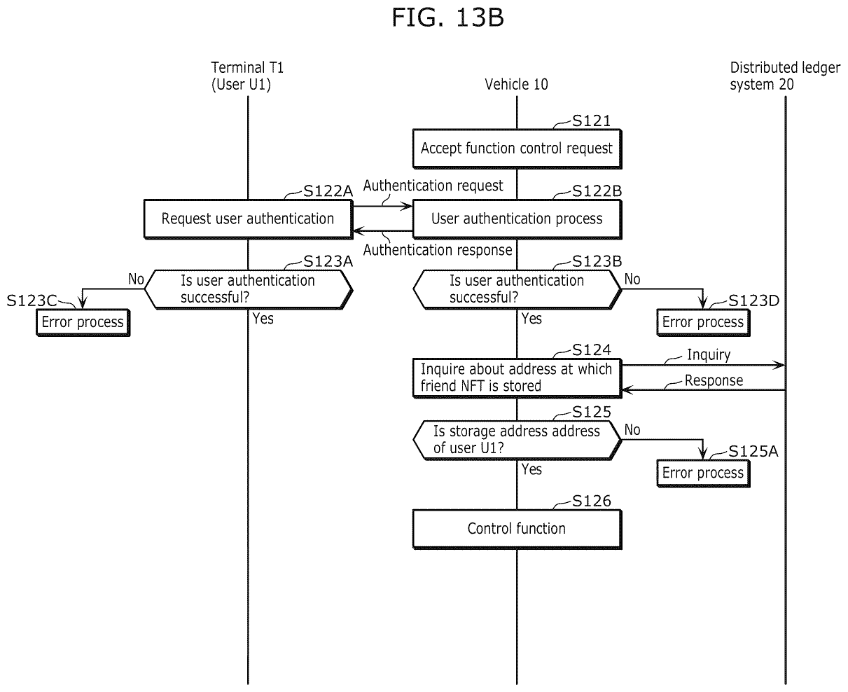

FIG. 11, FIG. 12, and FIG. 13A are sequence diagrams illustrating the processes performed by information processing system 1 when the owner grants the authority of use in the present embodiment.

In Step S201 (refer to FIG. 11), terminal T1 inquires of vehicle 10 about the address of the owner of vehicle 10, and receives a response including the address of the owner of vehicle 10. Terminal T1 can use short-range wireless communication for this inquiry transmission and this response reception.

In Step S202, authority manager 123 in terminal T1 obtains the contact information of the owner included in the owner NFT. Specifically, using the address of the owner of vehicle 10 included in the response received in Step S201, authority manager 123 in terminal T1 transmits a reference request for making reference to the address of the owner on the distributed ledger held by distributed ledger system 20, and receives a response including the information included in the owner NFT. Authority manager 123 in terminal T1 can obtain the contact information (for example, an e-mail address) of the owner from user info in the information included in the owner NFT.

In Step S203, authority manager 123 in terminal T1 obtains the authority information included in the owner NFT. Specifically, using the address of the owner of vehicle 10 included in the response received in Step S201, authority manager 123 in terminal T1 transmits a reference request for making reference to the address of the owner on the distributed ledger held by distributed ledger system 20, and receives a response including the information included in the owner NFT.

In Step S204, using the authority information obtained in Step S203, authority manager 123 in terminal T1 determines whether a new friend can be set as a subordinate of the owner. When it is determined that a new friend can be set as a subordinate of the owner (Yes in Step S204), the processing proceeds to Step S205; otherwise (No in Step S204), the processing proceeds to Step S204A.

In Step S204A, terminal T1 performs an error process. For example, as the error process, terminal T1 may display the result of the above determination on a display screen or may output the result of the above determination as sound and speech from a loudspeaker. Subsequently, information processing system 1 ends the series of processes illustrated in FIG. 11 to FIG. 13A.

For example, authority manager 123 in terminal T1 can refer to maximum number of depth and, assuming that a new friend is set as a subordinate of the owner, when the hierarchical level of the new friend is less than or equal to maximum number of depth, determine that a new friend can be set as a subordinate of the owner, and otherwise determine that a new friend cannot be set as a subordinate of the owner.

Furthermore, for example, authority manager 123 in terminal T1 can refer to maximum number of friend NFTs and, assuming that a new friend is set as a subordinate of the owner, when the total number of friends and secondary friends is less than or equal to maximum number of friend NFTs, determine that a new friend can be set as a subordinate of the owner, and otherwise determine that a new friend cannot be set as a subordinate of the owner.

In Step S205, authority manager 123 in terminal T1 transmits, to terminal T0, a setting request for setting a new friend. The setting request includes a public key certificate of user U1. Terminal T0 receives the setting request transmitted thereto.

In Step S206, authority manager 123 in terminal T0 verifies the public key certificate of user U1 received in Step S205.

In Step S207, authority manager 123 in terminal T0 determines whether the verification in Step S206 is successful. When it is determined that the verification is successful (Yes in Step S207), the processing proceeds to Step S211 (refer to FIG. 12); otherwise (No in Step S207), the processing proceeds to Step S207A.

In Step S207A, terminal T0 performs an error process. For example, as the error process, terminal T0 may display the result of the above verification on the display screen or may output the result of the above verification as sound and speech from the loudspeaker. Subsequently, information processing system 1 ends the series of processes illustrated in FIG. 11 to FIG. 13A.

In Step S211 (refer to FIG. 12), authority manager 123 in terminal T0 transmits a remuneration payment request to terminal T1. Terminal T1 receives the remuneration payment request transmitted thereto.

In Step S212, authority manager 123 in terminal T1 generates transaction data indicating a payment of remuneration (also referred to as payment transaction data) according to the reception of the remuneration payment request in Step S211, and transmits the transaction data to distributed ledger system 20. Note that the remuneration may be specifically a token (monetary value or information equivalent to monetary value).

In Step S213, authority manager 123 in terminal T0 checks whether the payment transaction data is stored in the distributed ledger. Specifically, authority manager 123 in terminal T0 transmits a reference request for making reference to the distributed ledger held by distributed ledger system 20, receives a response including information indicating whether the payment transaction data is stored in the distributed ledger, and thus can check whether the payment transaction data is stored in the distributed ledger.

In Step S214, authority manager 123 in terminal T0 determines whether the payment transaction data is stored in the distributed ledger. When it is determined that the payment transaction data is stored in the distributed ledger (Yes in Step S214), the processing proceeds to Step S215; otherwise (No in Step S214), the processing proceeds to Step S214A.

In Step S214A, terminal T0 performs an error process. For example, as the error process, terminal T0 may display the result of the above check on the display screen or may output the result of the above check as sound and speech from the loudspeaker. Subsequently, information processing system 1 ends the series of processes illustrated in FIG. 11 to FIG. 13A.

In Step S215, authority manager 123 in terminal T0 attaches a signature of user U0 to the public key of user U1.

In Step S216, authority manager 123 in terminal T0 transmits, to terminal T1, the public key of user U1 to which the signature of user U0 has been attached in Step S215. Terminal T1 receives the public key of user U1 transmitted thereto.

In Step S217, authority manager 123 in terminal T1 stores the public key of user U1 received in Step S216 to which the signature of user U0 has been attached.

In Step S221A (refer to FIG. 13A), authentication requester 122 in terminal T1 requests vehicle 10 to perform user authentication. For example, authentication requester 122 in terminal T1 requests authentication of user U1 by the challenge-response method. Furthermore, authentication requester 122 in terminal T1 receives an authentication response including the result of the authentication from vehicle 10.

In Step S221B, authenticator 103 in vehicle 10 receives the authentication request transmitted thereto in Step S221A, and performs the process of authenticating user U1 by the challenge-response method. Authenticator 103 in vehicle 10 transmits an authentication response including the result of the authentication (specifically, indicating whether the authentication is successful or unsuccessful) to terminal T1.

In Step S222A, from the authentication response received in Step S221A, authentication requester 122 in terminal T1 determines whether the authentication in Step S221B is successful. When it is determined that the above authentication is successful (Yes in Step S222A), the processing proceeds to Step S224; otherwise (No in Step S222A), the processing proceeds to Step S222C.

In Step S222C, terminal T1 performs an error process. For example, as the error process, terminal T1 may display the result of the above authentication on the display screen or may output the result of the above authentication as sound and speech from the loudspeaker. Subsequently, information processing system 1 ends the series of processes illustrated in FIG. 11 to FIG. 13A.

In Step S222B, authenticator 103 in vehicle 10 determines whether the authentication in Step S221B is successful. When it is determined that the above authentication is successful (Yes in Step S222B), the processing proceeds to Step S223; otherwise (No in Step S222B), the processing proceeds to Step S222D.

In Step S222D, vehicle 10 performs an error process. For example, as the error process, vehicle 10 may display the result of the above authentication on the display screen or may output the result of the above authentication as sound and speech from the loudspeaker. Subsequently, information processing system 1 ends the series of processes illustrated in FIG. 11 to FIG. 13A.

In Step S223, transaction processor 104 in vehicle 10 performs control such that the friend NFT is issued to user U1. Specifically, transaction processor 104 in vehicle 10 generates transaction data including information for causing the friend NFT to be issued to user U1 (also referred to as issuance transaction data), and transmits the transaction data to distributed ledger system 20.

In Step S224, authority manager 123 in terminal T1 stores the public key of vehicle 10 into storage 124. When the public key of vehicle 10 is stored in terminal T1, the next and subsequent signature verification can be performed rapidly. The public key to be stored is relatively reliable as a public key of vehicle 10, meaning that the public key can be used without repeated validity verification thereof; in other words, the process of validity verification can be omitted.

In Step S225, vehicle 10 stores the public key of user U1 into storage 106. When the public key of user U1 is stored in vehicle 10, the next and subsequent verification of a signature generated using the private key of user U1 can be performed rapidly.

In Step S226, distributed ledger system 20 issues the friend NFT to the address of user U1 according to the reception of the issuance transaction data in Step S223.

Note that in the control of distributed ledger system 20 such that the second NFT is issued, distributed ledger system 20 may be controlled to issue the second NFT according to a smart contract. Specifically, the determination processes included in Steps S202 to S204 or the processes included in Steps S212 to S214 may be performed according to a smart contract. In this case, transaction data including a contract code on which the above processes are written is stored in the distributed ledger in advance, and when terminal T1 generates transaction data to execute said contract code and transmits the transaction data to distributed ledger system 20, the above processes are performed according to the smart contract.

Note that processes SA in Steps S211 to S214 and S214A (refer to FIG. 12) are performed when the owner requests the friend to pay remuneration upon setting of the friend by the owner (in other words, when the owner sets the friend in exchange for remuneration) and are not performed when the owner does not request the friend to pay remuneration upon setting of the friend by the owner.

Through the series of processes illustrated in FIG. 11 to FIG. 13A, user U0, who is the owner, grants user U1 the authority to use vehicle 10, and thus user U1 can become a friend in information processing system 1. User U1 who has become a friend can use vehicle 10.

FIG. 13A is a sequence diagram illustrating the processes performed by information processing system 1 when the friend uses vehicle 10 in the present embodiment.

When user U0, who is the owner, grants user U1 the authority to use vehicle 10, information processing system 1 can control a function of vehicle 10 according to a request from the friend. Processes performed by information processing system 1 at this time are those indicated in FIG. 10 with terminal T0 replaced by terminal T1, user U0 replaced by user U1, and the owner NFT replaced by the friend NFT (refer to FIG. 13B).

Through the series of processes illustrated in FIG. 13B, information processing system 1 can control the function of vehicle 10 according to the request from the friend when the friend uses vehicle 10. At this time, since distributed ledger system 20 conducts proper management about whether the friend has the authority to use vehicle 10 according to whether the friend NFT has been issued to the friend, the use of vehicle 10 by the friend can be proper use based on the authority of use. Furthermore, when the friend is going to use vehicle 10, the validity period of the owner NFT managed by distributed ledger system 20 can be referred to so that whether the owner NFT is valid is checked before the use of vehicle 10 by the friend is permitted; in other words, the use of vehicle 10 can be prohibited when the owner NFT has expired.

Next described are the processes performed by information processing system 1 when user U1 who is the friend grants user U2 the authority to use vehicle 10. Note that user U2 becomes a secondary friend of vehicle 10 when granted the authority to use vehicle 10.

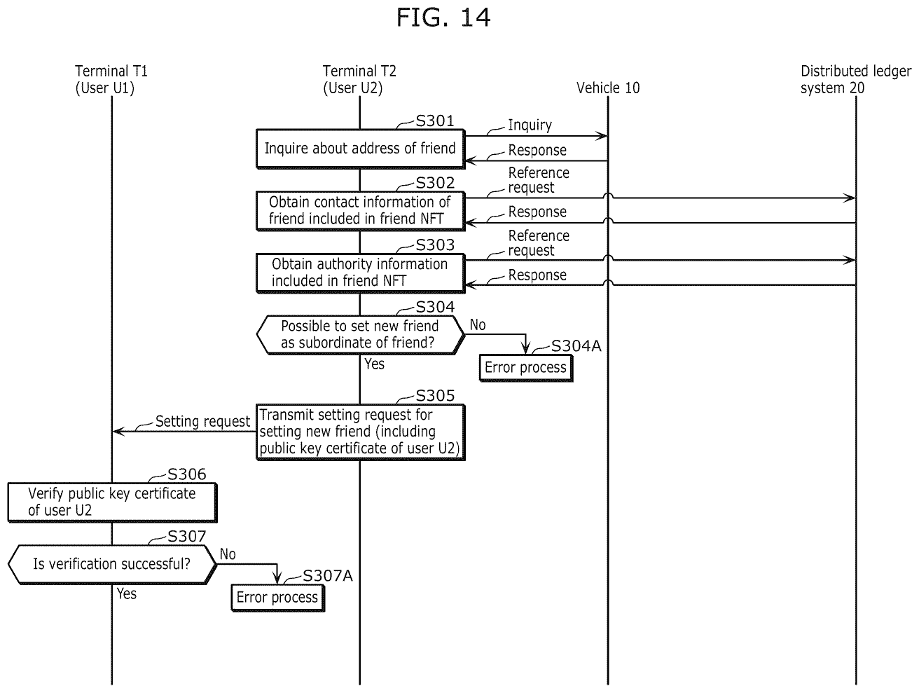

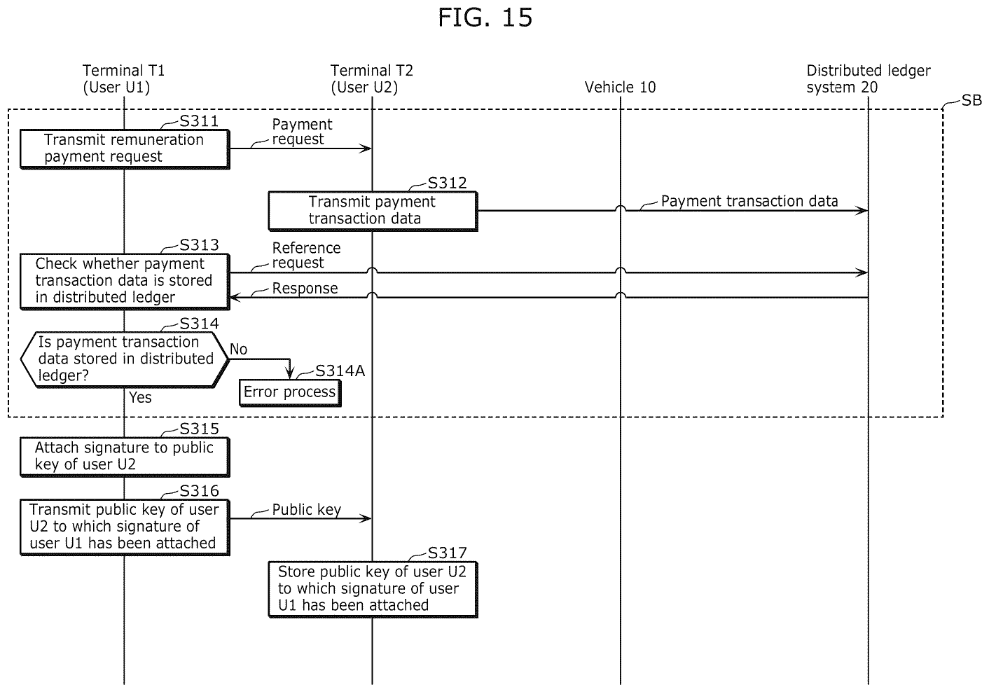

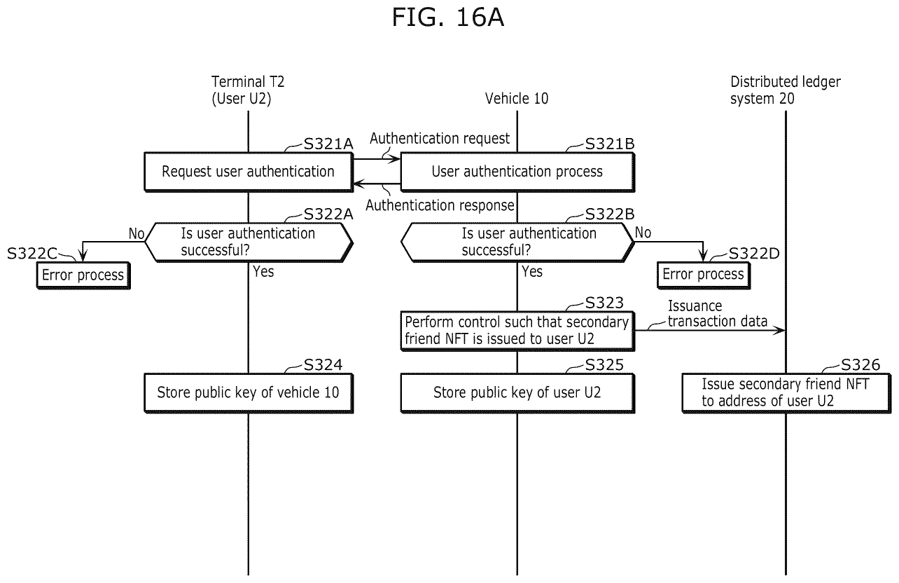

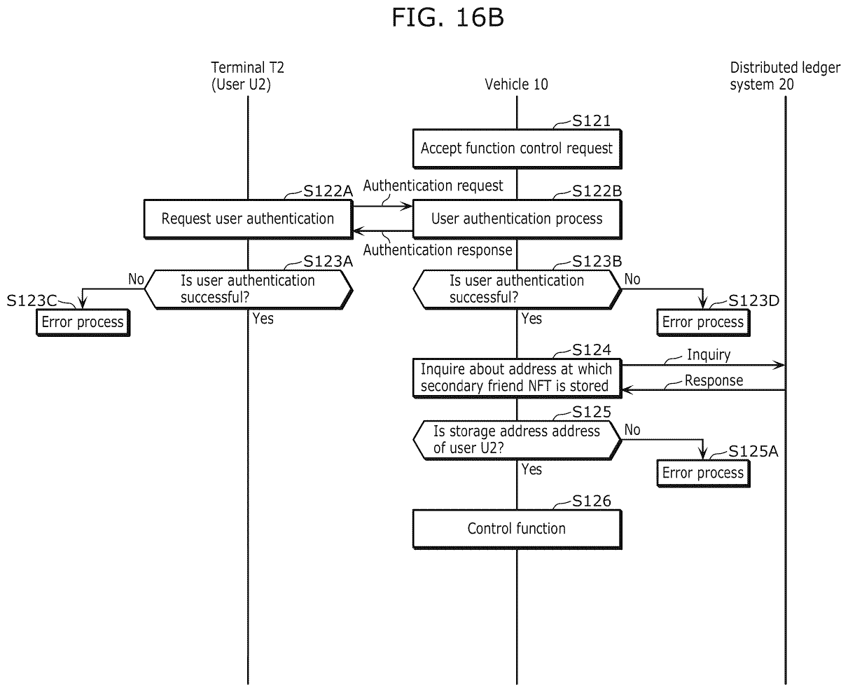

FIG. 14, FIG. 15, and FIG. 16A are sequence diagrams illustrating the processes performed by information processing system 1 when the friend grants the authority of use in the present embodiment.

In Step S301 (refer to FIG. 14), terminal T2 inquires of vehicle 10 about the address of the friend of vehicle 10, and receives a response including the address of the friend of vehicle 10. Terminal T2 can use short-range wireless communication for this inquiry transmission and this response reception.

In Step S302, authority manager 123 in terminal T2 obtains the contact information of the friend included in the friend NFT. Specifically, using the address of the friend of vehicle 10 included in the response received in Step S301, authority manager 123 in terminal T2 transmits a reference request for making reference to the address of the friend on the distributed ledger held by distributed ledger system 20, and receives a response including the information included in the friend NFT. Authority manager 123 in terminal T2 can obtain the contact information (for example, an e-mail address) of the friend from user info in the information included in the friend NFT.

In Step S303, authority manager 123 in terminal T2 obtains the authority information included in the friend NFT. Specifically, using the address of the friend of vehicle 10 included in the response received in Step S301, authority manager 123 in terminal T2 transmits a reference request for making reference to the address of the friend on the distributed ledger held by distributed ledger system 20, and receives a response including the information included in the friend NFT.

In Step S304, using the authority information obtained in Step S303, authority manager 123 in terminal T2 determines whether a new secondary friend can be set as a subordinate of the friend. When it is determined that a new secondary friend can be set as a subordinate of the friend (Yes in Step S304), the processing proceeds to Step S305; otherwise (No in Step S304), the processing proceeds to Step S304A.

In Step S304A, terminal T2 performs an error process. For example, as the error process, terminal T2 may display the result of the above determination on a display screen or may output the result of the above determination as sound and speech from a loudspeaker. Subsequently, information processing system 1 ends the series of processes illustrated in FIG. 14 to FIG. 16A.

For example, authority manager 123 in terminal T2 can refer to maximum number of depth and, assuming that a new secondary friend is set as a subordinate of the friend, when the hierarchical level of the new secondary friend is less than or equal to maximum number of depth, determine that a new secondary friend can be set as a subordinate of the friend, and otherwise determine that a new secondary friend cannot be set as a subordinate of the friend.

Furthermore, for example, authority manager 123 in terminal T2 can refer to maximum number of friend NFTs and, assuming that a new secondary friend is set as a subordinate of the friend, when the total number of friends and secondary friends is less than or equal to maximum number of friend NFTs, determine that a new secondary friend can be set as a subordinate of the friend, and otherwise determine that a new secondary friend cannot be set as a subordinate of the friend.

In Step S305, authority manager 123 in terminal T2 transmits, to terminal T1, a setting request for setting a new secondary friend. The setting request includes a public key certificate of user U2. Terminal T1 receives the setting request transmitted thereto.

In Step S306, authority manager 123 in terminal T1 verifies the public key certificate of user U2 received in Step S305.

In Step S307, authority manager 123 in terminal T1 determines whether the verification in Step S306 is successful. When it is determined that the verification is successful (Yes in Step S307), the processing proceeds to Step S311 (refer to FIG. 15); otherwise (No in Step S307), the processing proceeds to Step S307A.

In Step S307A, terminal T1 performs an error process. For example, as the error process, terminal T1 may display the result of the above verification on the display screen or may output the result of the above verification as sound and speech from the loudspeaker. Subsequently, information processing system 1 ends the series of processes illustrated in FIG. 14 to FIG. 16A.

In Step S311 (refer to FIG. 15), authority manager 123 in terminal T1 transmits a remuneration payment request to terminal T2. Terminal T2 receives the remuneration payment request transmitted thereto.

In Step S312, authority manager 123 in terminal T2 generates transaction data indicating a payment of remuneration (also referred to as payment transaction data) according to the reception of the remuneration payment request in Step S311, and transmits the transaction data to distributed ledger system 20. Note that the remuneration may be specifically a token (monetary value or information equivalent to monetary value).

In Step S313, authority manager 123 in terminal T1 checks whether the payment transaction data is stored in the distributed ledger. Specifically, authority manager 123 in terminal T1 transmits a reference request for making reference to the distributed ledger held by distributed ledger system 20, receives a response including information indicating whether the payment transaction data is stored in the distributed ledger, and thus can check whether the payment transaction data is stored in the distributed ledger.

In Step S314, authority manager 123 in terminal T1 determines whether the payment transaction data is stored in the distributed ledger. When it is determined that the payment transaction data is stored in the distributed ledger (Yes in Step S314), the processing proceeds to Step S315; otherwise (No in Step S314), the processing proceeds to Step S314A.

In Step S314A, terminal T1 performs an error process. For example, as the error process, terminal T1 may display the result of the above check on the display screen or may output the result of the above check as sound and speech from the loudspeaker. Subsequently, information processing system 1 ends the series of processes illustrated in FIG. 14 to FIG. 16A.

In Step S315, authority manager 123 in terminal T1 attaches a signature of user U1 to the public key of user U2.

In Step S316, authority manager 123 in terminal T1 transmits, to terminal T2, the public key of user U2 to which the signature of user U1 has been attached in Step S315. Terminal T2 receives the public key of user U2 transmitted thereto.

In Step S317, authority manager 123 in terminal T2 stores the public key of user U2 received in Step S316 to which the signature of user U1 has been attached.

In Step S321A (refer to FIG. 16A), authentication requester 122 in terminal T2 requests vehicle 10 to perform user authentication. For example, authentication requester 122 in terminal T2 requests authentication of user U2 by the challenge-response method. Furthermore, authentication requester 122 in terminal T2 receives an authentication response including the result of the authentication from vehicle 10.

In Step S321B, authenticator 103 in vehicle 10 receives the authentication request transmitted thereto in Step S321A, and performs the process of authenticating user U2 by the challenge-response method. Authenticator 103 in vehicle 10 transmits an authentication response including the result of the authentication (specifically, indicating whether the authentication is successful or unsuccessful) to terminal T2.

In Step S322A, from the authentication response received in Step S321A, authentication requester 122 in terminal T2 determines whether the authentication in Step S321B is successful. When it is determined that the above authentication is successful (Yes in Step S322A), the processing proceeds to Step S324; otherwise (No in Step S322A), the processing proceeds to Step S322C.

In Step S322C, terminal T2 performs an error process. For example, as the error process, terminal T2 may display the result of the above authentication on the display screen or may output the result of the above authentication as sound and speech from the loudspeaker. Subsequently, information processing system 1 ends the series of processes illustrated in FIG. 14 to FIG. 16A.

In Step S322B, authenticator 103 in vehicle 10 determines whether the authentication in Step S321B is successful. When it is determined that the above authentication is successful (Yes in Step S322B), the processing proceeds to Step S323; otherwise (No in Step S322B), the processing proceeds to Step S322D.

In Step S322D, vehicle 10 performs an error process. For example, as the error process, vehicle 10 may display the result of the above authentication on the display screen or may output the result of the above authentication as sound and speech from the loudspeaker. Subsequently, information processing system 1 ends the series of processes illustrated in FIG. 14 to FIG. 16A.

In Step S323, transaction processor 104 in vehicle 10 performs control such that the secondary friend NFT is issued to user U2. Specifically, transaction processor 104 in vehicle 10 generates transaction data including information for causing the secondary friend NFT to be issued to user U2 (also referred to as issuance transaction data), and transmits the transaction data to distributed ledger system 20. Distributed ledger system 20 receives the issuance transaction data transmitted thereto.

In Step S324, authority manager 123 in terminal T2 stores the public key of vehicle 10 into storage 124. When the public key of vehicle 10 is stored in terminal T2, the next and subsequent signature verification can be performed rapidly. The public key to be stored is relatively reliable as a public key of vehicle 10, meaning that the public key can be used without repeated validity verification thereof; in other words, the process of validity verification can be omitted.

In Step S325, vehicle 10 stores the public key of user U2 into storage 106. When the public key of user U2 is stored in vehicle 10, the next and subsequent verification of a signature generated using the private key of user U2 can be performed rapidly.

In Step S326, distributed ledger system 20 issues the secondary friend NFT to the address of user U2 according to the reception of the issuance transaction data in Step S323.

Note that in the control of distributed ledger system 20 such that the third NFT is issued, distributed ledger system 20 may be controlled to issue the third NFT according to a smart contract. Specifically, the determination processes included in Steps S302 to S304 or the processes included in Steps S312 to S314 may be performed according to a smart contract. In this case, transaction data including a contract code on which the above processes are written is stored in the distributed ledger in advance, and when terminal T2 generates transaction data to execute said contract code and transmits the transaction data to distributed ledger system 20, the above processes are performed according to the smart contract.

Note that processes SB in Steps S311 to S314 and S314A (refer to FIG. 15) are performed when the friend requests the secondary friend to pay remuneration upon setting of the secondary friend by the friend (in other words, when the friend sets the secondary friend in exchange for remuneration) and are not performed when the friend does not request the secondary friend to pay remuneration upon setting of the secondary friend by the friend.

Through the series of processes illustrated in FIG. 14 to FIG. 16A, user U1, who is the friend, grants user U2 the authority to use vehicle 10, and thus user U2 can become a secondary friend in information processing system 1. User U2 who has become a secondary friend can use vehicle 10.

FIG. 16B is a sequence diagram illustrating the processes performed by the information processing system when the secondary friend uses the vehicle in the present embodiment.

When user U1, who is the friend, grants user U2 the authority to use vehicle 10, information processing system 1 can control a function of vehicle 10 according to a request from the secondary friend. Processes performed by information processing system 1 at this time are those indicated in FIG. 10 with terminal T0 replaced by terminal T2, user U0 replaced by user U2, and the owner NFT replaced by the secondary friend NFT (refer to FIG. 16B).

Through the series of processes illustrated in FIG. 16B, information processing system 1 can control the function of vehicle 10 according to the request from the secondary friend when the secondary friend uses vehicle 10. At this time, since distributed ledger system 20 conducts proper management about whether the secondary friend has the authority to use vehicle 10 according to whether the secondary friend NFT has been issued to the secondary friend, the use of vehicle 10 by the secondary friend can be proper use based on the authority of use. Furthermore, when the secondary friend is going to use vehicle 10, the validity periods of the owner NFT and the friend NFT managed by distributed ledger system 20 can be referred to so that whether the owner NFT and the friend NFT are valid is checked before the use of vehicle 10 by the secondary friend is permitted; in other words, the use of vehicle 10 can be prohibited when the owner NFT or the friend NFT has expired.

Next described are the processes performed by information processing system 1 when the owner grants user U10 the authority to use vehicle 10. Note that when the ownership of vehicle 10 is transferred from the owner to user U10, user U10 becomes a new owner.

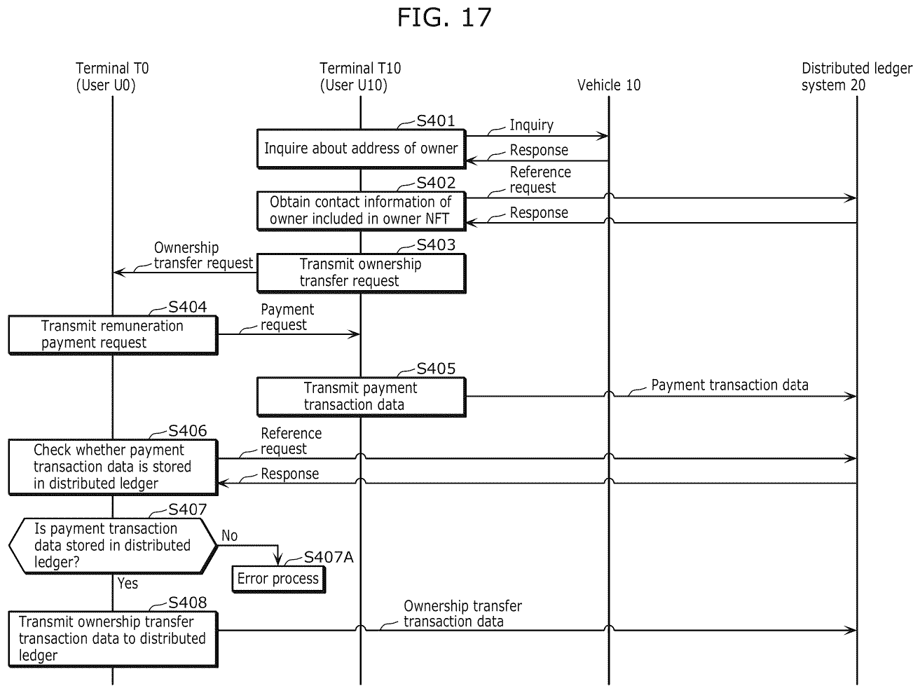

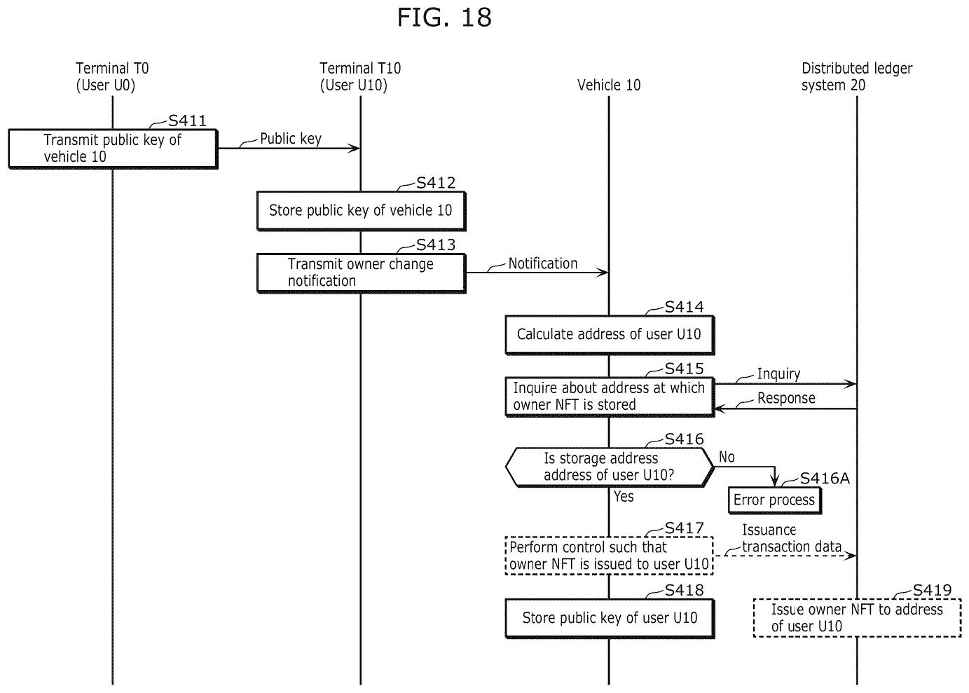

FIG. 17 and FIG. 18 are sequence diagrams illustrating the processes performed by information processing system 1 when the owner transfers the ownership of vehicle 10 in the present embodiment.

Terminal T10 indicated in FIG. 17 and FIG. 18 is an information terminal device held by user U10. Terminal T10 includes substantially the same structural elements as terminal T0.

In Step S401 (refer to FIG. 17), terminal T10 inquires of vehicle 10 about the address of the owner of vehicle 10, and receives a response including the address of the owner of vehicle 10. Terminal T10 can use short-range wireless communication for this inquiry transmission and this response reception.

In Step S402, authority manager 123 in terminal T10 obtains the contact information of the owner included in the owner NFT. Specifically, using the address of the owner of vehicle 10 included in the response received in Step S401, authority manager 123 in terminal T10 transmits a reference request for making reference to the address of the owner on the distributed ledger held by distributed ledger system 20, and receives a response including the information included in the owner NFT. Authority manager 123 in terminal T10 can obtain the contact information (for example, an e-mail address) of the owner from user info in the information included in the owner NFT.

In Step S403, authority manager 123 in terminal T10 transmits, to terminal T0, an ownership transfer request that requests the transfer of the ownership of vehicle 10 to user U10. Terminal T0 receives the ownership transfer request transmitted thereto.

In Step S404, authority manager 123 in terminal T0 transmits a remuneration payment request to terminal T10. Terminal T10 receives the remuneration payment request transmitted thereto.

In Step S405, authority manager 123 in terminal T10 generates transaction data indicating a payment of remuneration (also referred to as payment transaction data) according to the reception of the remuneration payment request in Step S404, and transmits the transaction data to distributed ledger system 20. Note that the remuneration may be specifically a token (monetary value or information equivalent to monetary value).

In Step S406, authority manager 123 in terminal T0 checks whether the payment transaction data is stored in the distributed ledger. Specifically, authority manager 123 in terminal T0 transmits a reference request for making reference to the distributed ledger held by distributed ledger system 20, receives a response including information indicating whether the payment transaction data is stored in the distributed ledger, and thus can check whether the payment transaction data is stored in the distributed ledger.

In Step S407, authority manager 123 in terminal T0 determines whether the payment transaction data is stored in the distributed ledger. When it is determined that the payment transaction data is stored in the distributed ledger (Yes in Step S407), the processing proceeds to Step S408; otherwise (No in Step S407), the processing proceeds to Step S407A.

In Step S407A, terminal T0 performs an error process. For example, as the error process, terminal T0 may display the result of the above check on the display screen or may output the result of the above check as sound and speech from the loudspeaker. Subsequently, information processing system 1 ends the series of processes illustrated in FIG. 17 and FIG. 18.

In Step S408, authority manager 123 in terminal T0 generates, on the distributed ledger, transaction data indicating the transfer of the ownership of vehicle 10 (also referred to as ownership transfer transaction data), and transmits the transaction data to distributed ledger system 20.

In Step S411 (refer to FIG. 18), authority manager 123 in terminal T0 transmits the public key of vehicle 10 to terminal T10. Terminal T10 receives the public key of vehicle 10 transmitted thereto. Note that in Step S411, terminal T10 may obtain the public key of vehicle 10 by a method other than the method in which the public key is received from terminal T0. In this case, authority manager 123 in terminal T0 does not need to transmit the public key of vehicle 10 to terminal T10.

In Step S412, terminal T10 stores, into storage 124, the public key of vehicle 10 received in Step S411.

In Step S413, authority manager 123 in terminal T10 transmits an owner change notification to vehicle 10. The owner change notification is a notification indicating that the owner of vehicle 10 has been changed from user U0 to user U10. Vehicle 10 receives the owner change notification transmitted thereto.

In Step S414, transaction processor 104 in vehicle 10 calculates an address of user U10. Transaction processor 104 in vehicle 10 can calculate the address of user U10 by using the public key of user U10. The calculation of the address by using the private key can be achieved using a well-known technique (for example, the address is calculated from the public key by using a hashing operation or the like).

In Step S415, transaction processor 104 in vehicle 10 inquires of distributed ledger system 20 about an address on the distributed ledger at which the owner NFT is stored (also referred to as a storage address), and receives a response including said storage address.

In Step S416, transaction processor 104 in vehicle 10 determines whether the storage address included in the response received in Step S415 is the address of user U10. When it is determined that the storage address is the address of user U10 (Yes in Step S416), the processing proceeds to Step S417; otherwise (No in Step S416), the processing proceeds to Step S416A.

In Step S416A, vehicle 10 performs an error process. For example, as the error process, vehicle 10 may display the result of the above authentication on the display screen or may output the result of the above authentication as sound and speech from the loudspeaker. Subsequently, information processing system 1 ends the series of processes illustrated in FIG. 17 and FIG. 18.

In Step S417, transaction processor 104 in vehicle 10 performs control such that the owner NFT is issued to user U10. Specifically, transaction processor 104 in vehicle 10 generates transaction data including information for causing the owner NFT to be issued to user U10 (also referred to as issuance transaction data), and transmits the transaction data to distributed ledger system 20. Distributed ledger system 20 receives the issuance transaction data transmitted thereto.

In Step S418, vehicle 10 stores the public key of user U10 into storage 106.

In Step S419, distributed ledger system 20 issues the owner NFT to the address of user U10 according to the reception of the issuance transaction data in Step S417.

Note that while the issuance of the new owner NFT to the new owner, i.e., user U10, by information processing system 1 has been described thus far, the new owner, i.e., user U10, can successively hold the owner NFT issued to the previous owner, i.e., user U1. In this case, Step S417 is skipped and as a result, Step S419 is also skipped.

Note that whether the new owner successively uses the owner NFT issued to the previous owner may be determined by information processing system 1 in advance or terminal T10 may notify vehicle 10 of whether to successively use the owner NFT issued to the previous owner. The notification of whether the new owner successively uses the owner NFT issued to the previous owner may be included in the owner change notification (refer to Step S413 in FIG. 18), for example.

As described above, information processing system 1 according to the present embodiment can properly control the authority to use vehicle 10.

### Variations of Embodiment

Regarding an information processing method, an information processing device, and an information processing system that contribute to appropriate control of the authority to use a device, a technique that even when a private key is leaked, properly contributes to appropriate control of the authority to use the device will be described in the present variation.

The configuration of information processing system 1 according to the present variation is substantially the same as that of information processing system 1 according to the above embodiment.

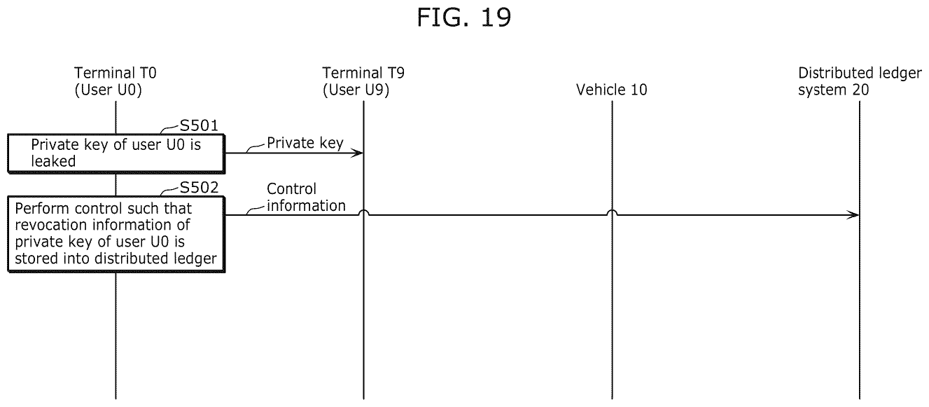

FIG. 19 is a sequence diagram illustrating the processes performed by information processing system 1 when the revocation information is registered in the present variation.

FIG. 19 illustrates the processes in which when the private key of user U0, who is the owner, is leaked, the revocation information for said private key is registered.

When the private key of the owner is leaked, information processing system 1 performs control such that revocation information with which the private key of the owner is revoked and to which a digital signature using the private key of the owner has been attached is stored into the distributed ledger. In this case, in the control of a function of vehicle 10, whether the revocation information for the private key of the owner is stored in the distributed ledger is further determined. Subsequently, even when it is determined that there is a match between the address of the owner and the storage address of the first NFT (the NFT including the information regarding the authority of use by the owner of vehicle 10), the control of the function is prohibited when it is determined the revocation information is stored in the distributed ledger.

This will be specifically described below.

User U9 indicated in FIG. 19 is one example of the user who has obtained the leaked private key of user U0. Terminal T9 is an information terminal device held by user U9. Terminal T9 includes substantially the same structural elements as terminal T0.

Assume that in Step S501, the private key of user U0 is leaked and terminal T9 obtains the leaked private key.

In Step S502, terminal T0 performs control such that the revocation information for the private key of user U0 is stored into the distributed ledger. Specifically, terminal T0 generates transaction data including information with which the private key of user U0 is revoked (also referred to as revocation transaction data), and transmits the transaction data to distributed ledger system 20. Distributed ledger system 20 receives the revocation transaction data transmitted thereto, and stores the revocation transaction data into the distributed ledger.

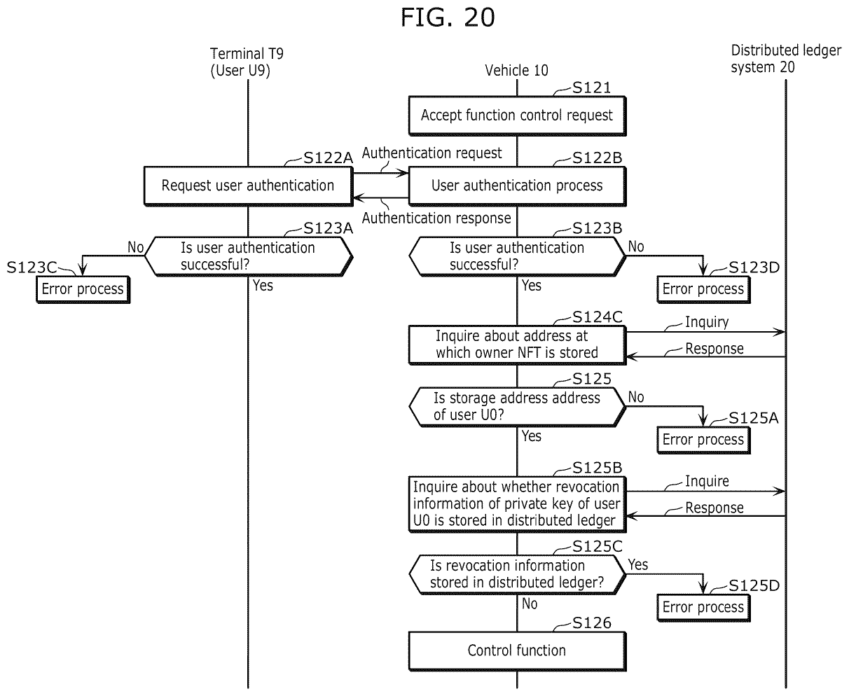

FIG. 20 is a sequence diagram illustrating the processes performed by information processing system 1 when the owner uses vehicle 10 in the present variation.

The processes in FIG. 20 performed by information processing system 1 when the owner uses vehicle 10 are substantially the same as the processes illustrated in FIG. 10, but are different from the processes illustrated in FIG. 10 in that the revocation information for the private key of user U0 is used. This feature will be mainly described.

Step S121 to Step S125 are substantially the same as the processes illustrated in FIG. 10.

In Step S125B, transaction processor 104 in vehicle 10 inquires of distributed ledger system 20 about whether the revocation information for the private key of user U0 is stored in the distributed ledger, and receives a response including information of whether the revocation information for the private key of user U0 is stored in the distributed ledger.

In Step S126, on the basis of the response received in Step S125B, transaction processor 104 in vehicle 10 determines whether the revocation information for the private key of user U0 is stored in the distributed ledger. When it is determined that the revocation information for the private key of user U0 is stored in the distributed ledger (Yes in Step S125C), the processing proceeds to Step S125D; otherwise (No in Step S125C), the processing proceeds to Step S126.

In Step S126, function controller 105 in vehicle 10 controls the function of vehicle 10 according to the request accepted in Step S121.

Through the series of processes illustrated in FIG. 20, information processing system 1 can control the function of vehicle 10 according to the request from the owner when the owner uses vehicle 10, and when the private key of the owner is revoked, prohibit the control of the function.

Note that in the above embodiment, each of the structural elements may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or a semiconductor memory. Here, the software program for realizing the information processing device, etc., according to the above embodiment is a program described below.

Specifically, this program causes a computer to perform an information processing method that is performed by a device and includes: obtaining an owner address and first authority information, the owner address being an address of an owner of the device on a distributed ledger, the first authority information including information regarding authority of use by the owner of the device; and controlling a distributed ledger system to issue a first non-fungible token (NFT) including the first authority information to the owner address.

The information processing method, etc., according to one or more aspects have been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### Industrial Applicability

The present disclosure is usable for a device that controls the authority to use a device.

1. An information processing method that is performed by a device, the information processing method comprising:
obtaining an owner address and first authority information, the owner address being an address of an owner of the device on a distributed ledger, the first authority information including information regarding authority of use by the owner of the device; and
controlling a distributed ledger system to issue a first non-fungible token (NFT) including the first authority information to the owner address.

2. The information processing method according to claim 1, further comprising:
in controlling one function by the device,
obtaining the owner address;
obtaining a first storage address that is an address on the distributed ledger at which the first NFT is stored;
determining whether there is a match between the owner address and the first storage address; and
when it is determined that there is a match between the owner address and the first storage address, controlling the one function.

3. The information processing method according to claim 1, further comprising:
when the owner is to grant a user authority to use the device, obtaining second authority information including information regarding authority of use by the user of the device; and
controlling the distributed ledger system to issue a second NFT including the second authority information to a user address that is an address of the user on the distributed ledger.

4. The information processing method according to claim 3, comprising:
in controlling one function by the device,
obtaining the user address;
obtaining a second storage address that is an address on the distributed ledger at which the second NFT is stored;
determining whether there is a match between the user address and the second storage address; and
when it is determined that there is a match between the user address and the second storage address, controlling the one function.

5. The information processing method according to claim 3, wherein
in the controlling of the distributed ledger system to issue the second NFT,
the distributed ledger system is controlled to issue the second NFT according to a smart contract.

6. The information processing method according to claim 3, further comprising:
when the user is to grant a secondary user authority to use the device, obtaining third authority information including information regarding authority of use by the secondary user of the device; and
controlling the distributed ledger system to issue a third NFT including the third authority information to a secondary user address that is an address of the secondary user on the distributed ledger.

7. The information processing method according to claim 6, further comprising:
in controlling one function by the device,
obtaining the secondary user address;
obtaining a third storage address that is an address on the distributed ledger at which the third NFT is stored;
determining whether there is a match between the secondary user address and the third storage address; and
when it is determined that there is a match between the secondary user address and the third storage address, controlling the one function.

8. The information processing method according to claim 6, wherein
in issuing the third NFT,
the distributed ledger system is controlled to issue the third NFT according to a smart contract.

9. The information processing method according to claim 1, further comprising:
when a private key of the owner is leaked, performing control to store, into the distributed ledger, revocation information with which the private key of the owner is revoked and to which a digital signature using the private key of the owner has been attached.

10. The information processing method according to claim 9, further comprising:
in controlling one function by the device,
obtaining the owner address;
obtaining a first storage address that is an address on the distributed ledger at which the first NFT is stored;
determining whether the revocation information for the private key of the owner is stored in the distributed ledger; and
when it is determined that the revocation information for the private key of the owner is stored in the distributed ledger, prohibiting controlling the one function even when it is determined that there is a match between the owner address and the first storage address.

11. The information processing method according to claim 1, wherein
the first authority information includes information indicating a limitation imposed by the owner on use of the device.

12. The information processing method according to claim 11, wherein
the first authority information includes a validity period of the first NFT.

13. The information processing method according to claim 11, wherein
the first authority information includes information indicating presence or absence of authority to issue a second NFT including second authority information including information regarding authority of use by a user of the device.

14. The information processing method according to claim 11, wherein
the first authority information includes function control approval and disapproval information determined for each device.

15. The information processing method according to claim 1, further comprising:
in transferring the first NFT by the distributed ledger system,
controlling the distributed ledger system to transfer value information as remuneration for the first NFT.

16. The information processing method according to claim 15, wherein
in the controlling of the distributed ledger system to transfer the value information,
the distributed ledger system is controlled according to a smart contract to transfer the value information.

17. The information processing method according to claim 1, wherein
the address on the distributed ledger is an address calculated in advance using a private key of the owner.

18. The information processing method according to claim 17, wherein
the distributed ledger system is controlled using the private key as a digital key defined by the Car Connectivity Consortium (CCC).

19. An information processing device comprising:
an obtainer that obtains an owner address and first authority information, the owner address being an address of an owner of the information processing device on a distributed ledger, the first authority information including information regarding authority of use by the owner of the information processing device; and
a processor that controls a distributed ledger system to issue a first non-fungible token (NFT) including the first authority information to the owner address.

20. An information processing system comprising:
the information processing device according to claim 19;
an information processing terminal held by the owner; and
the distributed ledger system.
